(19) United States
(12) Patent Application Publication
(10) Pub. No.: US 2009/0239616 A1
(43) Pub. Date: Sep. 24, 2009

(54) Slot Machine Capable Of Changing Odds And Control Method Thereof

(75) Inventor: Tomoaki Oomori, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/195,768

(22) Filed: Aug. 21, 2008

Related U.S. Application Data
(60) Provisional application No. 61/038,505, filed on Mar. 21, 2008.

(51) Int. Cl. A63F 13/00

(52) U.S. Cl. 463/20

(57) ABSTRACT

A slot machine of the present invention comprises a symbol display capable of stop-displaying an odds-change symbol. An amount of payout is determined, when the odds-change symbol has been stop-displayed, based on special odds different from normal odds, in a game subsequent to the game in which the odds-change symbol has been stop-displayed. Namely the odds are changed.

### CROSS-REFERENCE TO RELATED APPLICATIONS

This application claims benefit of priority based on US Provisional Patent Application No. 61/038,505 filed on Mar. 21, 2008. The contents of this application are incorporated herein by reference in their entirety.

### BACKGROUND OF THE INVENTION

1. Field of the Invention

The present invention relates to a slot machine capable of changing odds and a control method thereof.

2. Discussion of the Background

In conventional slot machines, when a player inserts game media such as medals, coins or bills into an insertion slot of the slot machine and presses a spin button, then a plurality of symbols are scroll-displayed to a display portion provided on the front surface of a casing and, thereafter, the respective symbols are automatically stopped, as disclosed in U.S. Pat. Nos. 6,960,133, 6,012,983 and 6,093,102. In this case, when scroll-display of respective symbols starts by an input from the spin button, symbols are selected using random numbers, and the selected symbols are stop-displayed to the display portion. Then, when a combination of the stop-displayed symbols along a winning line is a predetermined winning combination (prize), a payout is conducted.

Further, among conventional slot machines, there are some slot machines which conduct two types of payouts which are a payout determined according to the combinations of symbols rearranged along winning lines and a payout determined according to the number of displayed scatter symbols, as disclosed in U.S. Pat. No. 6,604,999 and US 2002-0065124-A1. In such a slot machine which conducts payouts based on such scatter symbols, there is no relationship between payouts and positions at which the scatter symbols are displayed.

In such a conventional slot machine, in general, odds are preliminary determined for each type of prizes. In the present description, odds show a relation between the type of the prize and an amount of game media to be paid out in the case of establishment of the prize. For example, in many slot machines, a number of a coin to be paid out based on the establishment of a prize in the case that the prize is established when a single coin is BET (number of payouts per single coin) is determined for each type of the prizes.

However, since such odds are generally not changed during the game, there has been a problem that the player may be tired of the game while playing the game with fixed odds.

In light of the aforementioned problem, the present invention has been devised, and an object of the present invention is to provide a slot machine capable of changing odds and a control method thereof.

The contents of U.S. Pat. No. 6,960,133, U.S. Pat. No. 6,012,983, U.S. Pat. No. 6,093,102, U.S. Pat. No. 6,604,999 and U.S. 2002-0065124-A1 are incorporated herein by reference in their entirety.

### SUMMARY OF THE INVENTION

The present invention provides a slot machine having the following configuration.

That is, the slot machine comprises: a symbol display capable of variably displaying a plurality of symbols including a normal symbol and an odds-change symbol as a trigger for changing odds; and a controller. The controller is programmed to execute processing of (A) stop-displaying the plurality of symbols after variably displaying the plurality of symbols, to the symbol display, (B) determining an amount of payout based on normal odds indicating a relation between the stop-displayed normal symbol and the amount of payout and on the normal symbol stop-displayed in the processing (A), (C) determining, when the odds-change symbol has been stop-displayed in the processing (A), the amount of payout based on special odds different from the normal odds and on the normal symbol stop-displayed in the processing (A), instead of executing the processing (B), in a game subsequent to the game in which the odds-change symbol has been stop-displayed, and (D) paying out a game medium in the amount of payout determined in any one of the processing (B) and the processing (C).

According to the slot machine, the odds-change symbols can be stop-displayed to the symbol display. In the case that the odds-change symbol is stop-displayed, the amount of payout is determined based on the special odds different from the normal odds, in the game subsequent to the game in which the odds-change symbol has been stop-displayed. Namely, the odds are changed.

As thus described, according to the slot machine, the odds are changed as triggered by the stop-display of the odds-change symbol. Accordingly, it becomes possible to have a player enjoy the change of the odds and thus fully enjoy the game.

Further, since the odds are changed in the case that the odds-change symbol has been stop-displayed, it is possible to make the player have an interest and an attention on the odds-change symbol. Furthermore, it is possible to have the player play the game with a high expectation for the stop-display of the odds-change symbol, and the player can be absorbed in the game. Consequently, it is possible to provide a game that the player hardly gets tired even playing for a long time.

Further, the slot machine of the present invention preferably has the following configuration.

That is, the processing (C) is processing of determining, when a number of the odds-change symbol stop-displayed in the processing (A) satisfies a predetermined condition, the amount of payout based on the special odds and on the normal symbol stop-displayed in the processing (A), in the game subsequent to the game in which the number of the odds-change symbol stop-displayed has satisfied the predetermined condition.

According to the slot machine, the odds are changed in the case that the number of the odds-change symbol stop-displayed satisfies the predetermined condition. Accordingly, whether or not the number of odds-change symbol satisfies the predetermined condition, namely, how many odds-change symbols are stop-displayed is of great concern for the player. Therefore, it is possible to have the player find great pleasure in counting the number of the odds-change symbol while playing the game. Consequently, it is possible to have the player fully enjoy the game.

Further, the slot machine of the present invention preferably has the following configuration.

That is, the processing (C) is processing of determining the amount of normal payout based on the special odds corresponding to the number of the odds-change symbol stop-displayed in the processing (A) and on the normal symbol stop-displayed in the processing (A).

According to the slot machine, in the case that the number of the odds-change symbol stop-displayed satisfies the predetermined condition, the odds in the game subsequent to the game in which the number of the odds-change symbol stop-displayed has satisfied the predetermined condition are changed to the special odds corresponding to the number of the odds-change symbol stop-displayed. Namely, the changed odds can be varied according to the number of the odds-change symbol stop-displayed. Accordingly, it is possible to significantly increase the attention of the player on the number of the odds-change symbol stop-displayed.

Further, there may be occurred a case where the odds are changed to relatively advantageous odds or disadvantageous odds for the player, according to the number of the odds-change symbol stop-displayed. In the case that odds are changed to the relatively advantageous odds for the player, the player may be delighted, and on the other hand, in the case that odds are changed to the disadvantageous odds for the player, the player may be disappointed. As thus described, the change of odds can take the player through emotional ups and downs. Consequently, the player can be absorbed in the game.

Further, the slot machine of the present invention preferably has the following configuration.

That is, the slot machine comprises: a symbol display capable of variably displaying a plurality of symbols including a normal symbol and an odds-change symbol as a trigger for changing odds; and a controller. The controller is programmed to execute processing of (A) stop-displaying the plurality of symbols after variably displaying the plurality of symbols, to the symbol display, following a BET of a game medium in amount corresponding to natural number multiple of a predetermined minimum BET unit; (B) determining an amount of payout based on normal odds indicating a relation between the stop-displayed normal symbol and the amount of payout and on the normal symbol stop-displayed in the processing (A), (C) stop-displaying, when the odds-change symbol is stop-displayed in the processing (A), the plurality of symbols after variably displaying the plurality of symbols, to the symbol display, following the BET of the game medium in amount corresponding to the natural number multiple of a special BET unit bigger than the minimum BET unit, in a game subsequent to the game in which the odds-change symbol has been stop-displayed, (D) determining the amount of payout based on special odds different from the normal odds and on the normal symbol stop-displayed in the processing (C), and (E) paying out the game medium in the amount of payout determined in any one of the processing (B) and the processing (D).

According to the slot machine, the odds-change symbols can be stop-displayed to the symbol display. In the case that the odds-change symbol is stop-displayed, the amount of payout is determined based on the special odds different from the normal odds, in the game subsequent to the game in which the odds-change symbol has been stop-displayed. Namely, the odds are changed.

As thus described, according to the slot machine, the odds are changed as triggered by the stop-display of the odds-change symbol. Accordingly, it becomes possible to have a player enjoy the change of the odds and thus fully enjoy the game.

Further, since the odds are changed in the case that the odds-change symbol has been stop-displayed, it is possible to make the player have an interest and an attention on the odds-change symbol. Furthermore, it is possible to have the player play the game with a high expectation for the stop-display of the odds-change symbol, and the player can be absorbed in the game. Consequently, it is possible to provide a game that the player hardly gets tired even playing for a long time.

Further, according to the slot machine, in the game in which the amount of payout is determined based on the normal odds (in the present description, referred to as normal game), the variable-display and the stop-display of the plurality of symbols are conducted after the game medium in the amount corresponding to the natural number multiple of the minimum BET unit is BET. On the other hand, in the game in which the amount of payout is determined based on the special odds (in the present description, referred to as special game), the variable-display and the stop-display of the plurality of symbols are conducted after the game medium in the amount corresponding to the natural number multiple of the special BET unit is BET. The special BET unit is bigger than the minimum BET unit.

Namely, according to the slot machine, the BET unit (the minimum unit to BET) in the special game is bigger than the BET unit in the normal game. Accordingly, it is possible to have the player place a BET of the game medium in a big number, which leads to a profit increase of a recreation hall. Further, not only the odds, but also the BET unit is changed as triggered by the stop-display of the odds-change symbol. Accordingly, it is possible to provide an unpredictable element to the player and increase an interesting aspect of the game. Furthermore, since the player can acquire a big payout by placing a BET of the game medium in a big number under a condition of the increased BET unit, it is possible to increase the player's expectation for the payout.

Further, the slot machine of the present invention preferably has the following configuration.

That is, the slot machine further comprising an input device with which a player can input an order relating to the game. Furthermore, the controller is programmed to execute processing of: (F) accepting from the input device an input of an disapproval order of a change indicating disapproval for the change in odds, and the processing (C) is processing of stop-displaying the plurality of symbols after variably displaying the plurality of symbols, to the symbol display, following the BET of the game medium in amount corresponding to the natural number multiple of the special BET unit, on condition that the input of the disapproval order of the change has not been made in the processing (F).

According to the slot machine, the BET unit is changed to the special BET unit on condition that the disapproval order of the change has not been inputted. Namely, the player can prevent the increase in the BET unit by inputting the disapproval order of the change. Accordingly, the player reluctant to BET the game media in a large number can continue the game based on the minimum BET unit. Consequently, it is possible to provide a sense of satisfaction to the player.

Further, according to the slot machine, in the case that the disapproval order of change is inputted, the odds are not changed. Therefore, in the case that the player wishes to change the odds while not wishing to change the BET unit, the player has choices, namely, changing the odds or not changing the BET unit. Concurrently, it is possible to have the player go through a process of trial and error in selecting either choice, and through such a process, the player can be absorbed in the game.

The present invention provides a slot machine having the following configuration.

That is, the aforementioned slot machine comprises: a symbol display capable of stop-displaying a plurality of symbols including a normal symbol and an odds-change symbol as a trigger for changing odds after variably displaying the plurality of symbols; a memory capable of storing normal odds data indicating a relation between the normal symbol stop-displayed to the symbol display and an amount of payout and being to be referred to when the odds-change symbol has not been stop-displayed, and special odds data to be referred to when the odds-change symbol has been stop-displayed; and a controller. The controller is programmed to execute processing of (A) stop-displaying the plurality of symbols after variably displaying the plurality of symbols, to the symbol display, (B) determining the amount of payout based on the normal symbol stop-displayed in the processing (A) and on the normal odds data stored in the memory when the odds-change symbol has not been stop-displayed in the processing (A), (C) determining the amount of payout based on the normal symbol stop-displayed in the processing (A) and on the special odds data stored in the memory, when the odds-change symbol has been stop-displayed in the processing (A), (D) paying out a game medium in the amount of payout determined in any one of the processing (B) and the processing (C).

According to the slot machine, the odds-change symbols can be stop-displayed to the symbol display. In the case that the odds-change symbol is stop-displayed, the amount of payout is determined with reference to the special odds data different from the normal odds data to be referred to when the odds-change symbol is not stop-displayed.

As thus described, according to the slot machine, the payout is conducted based the unusual odds (odds indicated by the special odds data) as triggered by the stop-display of the odds-change symbol. Accordingly, it becomes possible to have a player enjoy the variety of the odds and thus fully enjoy the game.

Further, since the payout is conducted based on the unusual odds in the case that the odds-change symbol has been stop-displayed, it is possible to make the player have an interest and an attention on the odds-change symbol. Furthermore, it is possible to have the player play the game with a high expectation for the stop-display of the odds-change symbol, and the player can be absorbed in the game. Consequently, it is possible to provide a game that the player hardly gets tired even playing for a long time.

Further, the slot machine of the present invention preferably has the following configuration.

That is, the processing (C) is processing of determining the amount of payout based on the normal symbol stop-displayed in the processing (A) and on the special odds data stored in the memory, when a number of the odds-change symbol stop-displayed in the processing (A) satisfies a predetermined condition.

According to the slot machine, the payout is conducted based on the unusual odds in the case that the number of the odds-change symbol stop-displayed satisfies the predetermined condition. Accordingly, whether or not the number of odds-change symbol satisfies the predetermined condition, namely, how many odds-change symbols are stop-displayed is of great concern for the player. Therefore, it is possible to have the player find great pleasure in counting the number of the odds-change symbol while playing the game. Consequently, it is possible to have the player fully enjoy the game.

Further, the slot machine of the present invention preferably has the following configuration.

That is, a plurality of the special odds data are stored in the memory, and each special odds data is associated with the number of the odds-change symbol stop-displayed to the symbol display. The processing (C) is processing of determining the amount of payout based on the normal symbol stop-displayed in the processing (A) and on the special odds data associated with the number of the odds-change symbol stop-displayed in the processing (A).

According to the slot machine, in the case that the number of the odds-change symbol stop-displayed satisfies the predetermined condition, the special odds data corresponding to the number of the odds-change symbol stop-displayed is to be referred when the amount of payout is determined. Namely, the payout based on the different odds can be conducted according to the number of the odds-change symbol stop-displayed. Accordingly, it is possible to significantly increase the attention of the player on the number of the odds-change symbol stop-displayed.

Further, there may be occurred a case where the payout is conducted based on the relatively advantageous odds or the disadvantageous odds for the player, according to the number of the odds-change symbol stop-displayed. In the case that the payout is conducted based on the relatively advantageous odds for the player, the player may be delighted, and on the other hand, in the case that the payout is conducted based on the disadvantageous odds for the player, the player may be disappointed. As thus described, the variety of odds based on the payout can take the player through emotional ups and downs. Consequently, the player can be absorbed in the game.

Further, the present invention provides a control method of a slot machine.

That is, the control method of a slot machine comprises steps of: (A) stop-displaying a plurality of symbols including a normal symbol and an odds-change symbol as a trigger for changing odds, after variably displaying the plurality of symbols to the symbol display; (B) determining an amount of payout based on normal odds indicating a relation between the stop-displayed normal symbol and the amount of payout and on the normal symbol stop-displayed in the step (A); (C) determining, when the odds-change symbol has been stop-displayed in the step (A), the amount of payout based on special odds different from the normal odds and on the normal symbol stop-displayed in the step (A), instead of executing the step (B), in a game subsequent to the game in which the odds-change symbol has been stop-displayed, and (D) paying out a game medium in the amount of payout determined in any one of the step (B) and the step (C).

According to the control method of the slot machine, the odds-change symbols can be stop-displayed to the symbol display. In the case that the odds-change symbol is stop-displayed, the amount of payout is determined based on the special odds different from the normal odds, in the game subsequent to the game in which the odds-change symbol has been stop-displayed. Namely, the odds are changed.

As thus described, according to the control method of the slot machine, the odds are changed as triggered by the stop-display of the odds-change symbol. Accordingly, it becomes possible to have a player enjoy the change of the odds and thus fully enjoy the game.

Further, since the odds are changed in the case that the odds-change symbol has been stop-displayed, it is possible to make the player have an interest and an attention on the odds-change symbol. Furthermore, it is possible to have the player play the game with a high expectation for the stop-display of the odds-change symbol, and the player can be absorbed in the game. Consequently, it is possible to provide a game that the player hardly gets tired even playing for a long time.

Further, the present invention provides a control method of a slot machine. That is the control method of a slot machine comprises steps of: (A) stop-displaying a plurality of symbols including a normal symbol and an odds-change symbol as a trigger for changing odds, after variably displaying the plurality of symbols to the symbol display, following a BET of a game medium in amount corresponding to natural number multiple of a predetermined minimum BET unit; (B) determining an amount of payout based on normal odds indicating a relation between the stop-displayed normal symbol and the amount of payout and on the normal symbol stop-displayed in the step (A), (C) stop-displaying, when the odds-change symbol is stop-displayed in the step (A), the plurality of symbols after variably displaying the plurality of symbols, to the symbol display, following the BET of the game medium in amount corresponding to the natural number multiple of a special BET unit bigger than the minimum BET unit, in a game subsequent to the game in which the odds-change symbol has been stop-displayed, (D) determining the amount of payout based on special odds different from the normal odds and on the normal symbol stop-displayed in the step (C), and (E) paying out the game medium in the amount of payout determined in any one of the step (B) and the step (D).

According to the control method of the slot machine, the odds-change symbols can be stop-displayed to the symbol display. In the case that the odds-change symbol is stop-displayed, the amount of payout is determined based on the special odds different from the normal odds, in the game subsequent to the game in which the odds-change symbol has been stop-displayed. Namely, the odds are changed.

As thus described, according to the control method of the slot machine, the odds are changed as triggered by the stop-display of the odds-change symbol. Accordingly, it becomes possible to have a player enjoy the change of the odds and thus fully enjoy the game.

Further, since the odds are changed in the case that the odds-change symbol has been stop-displayed, it is possible to make the player have an interest and an attention on the odds-change symbol. Furthermore, it is possible to have the player play the game with a high expectation for the stop-display of the odds-change symbol, and the player can be absorbed in the game. Consequently, it is possible to provide a game that the player hardly gets tired even playing for a long time.

Further, according to the control method of the slot machine, in the game in which the amount of payout is determined based on the normal odds, the variable-display and the stop-display of the plurality of symbols are conducted after the game medium in the amount corresponding to the natural number multiple of the minimum BET unit is BET. On the other hand, in the game in which the amount of payout is determined based on the special odds, the variable-display and the stop-display of the plurality of symbols are conducted after the game medium in the amount corresponding to the natural number multiple of the special BET unit is BET. The special BET unit is bigger than the minimum BET unit.

Namely, according to the control method of the slot machine, the BET unit (the minimum unit to BET) in the special game is bigger than the BET unit in the normal game. Accordingly, it is possible to have the player place a BET of the game medium in a big number, which leads to a profit increase of a recreation hall. Further, not only the odds, but also the BET unit is changed as triggered by the stop-display of the odds-change symbol. Accordingly, it is possible to provide an unpredictable element to the player and increase an interesting aspect of the game. Furthermore, since the player can-acquire a big payout by placing a BET of the game medium in a big number under a condition of the increased BET unit, it is possible to increase the player's expectation for the payout.

Further, the present invention provides a control method of a slot machine. That is the control method of a slot machine comprises steps of: (A) stop-displaying a plurality of symbols including a normal symbol and an odds-change symbol as a trigger for changing odds after variably displaying the plurality of symbols, to the symbol display, (B) determining an amount of payout based on the normal symbol stop-displayed in the step (A) and on normal odds data indicating a relation between the stop-displayed normal symbol and the amount of payout, when the odds-change symbol has not been stop-displayed in the step (A), (C) determining the amount of payout based on the normal symbol stop-displayed in the step (A) and on the special odds data different from the normal odds data, when the odds-change symbol has been stop-displayed in the step (A), and (D) paying out a game medium in the amount of payout determined in any one of the step (B) and the step (C).

According to the control method of the slot machine, the odds-change symbols can be stop-displayed to the symbol display. In the case that the odds-change symbol is stop-displayed, the amount of payout is determined with reference to the special odds data different from the normal odds data to be referred to when the odds-change symbol is not stop-displayed.

As thus described, according to the control method of the slot machine, the payout is conducted based the unusual odds (odds indicated by the special odds data) as triggered by the stop-display of the odds-change symbol. Accordingly, it becomes possible to have a player enjoy the variety of the odds and thus fully enjoy the game.

Further, since the payout is conducted based on the unusual odds in the case that the odds-change symbol has been stop-displayed, it is possible to make the player have an interest and an attention on the odds-change symbol. Furthermore, it is possible to have the player play the game with a high expectation for the stop-display of the odds-change symbol, and the player can be absorbed in the game. Consequently, it is possible to provide a game that the player hardly gets tired even playing for a long time.

### BRIEF DESCRIPTIONS OF DRAWINGS

FIG. 1A is a view illustrating an exemplary symbol matrix.

FIG. 1B is a view illustrating an exemplary image to be displayed to a lower image display panel.

FIG. 2 is a view illustrating a relation among a number of rearranged odds-change symbol and a special game and special odds.

FIG. 3A is a view illustrating normal odds.

FIG. 3B is a view illustrating special odds A.

FIG. 3C is a view illustrating special odds B.

FIG. 3D is a view illustrating special odds C.

FIG. 4 is a perspective view illustrating the external appearance of a slot machine.

FIG. 5 is a block diagram illustrating an internal configuration of the slot machine illustrated in FIG. 4.

FIG. 6 is a flowchart illustrating main processing executed in the slot machine 10 according to a first embodiment.

FIG. 7 is a flowchart illustrating a subroutine of normal game execution processing.

FIG. 8 is a flowchart illustrating a subroutine of special game A execution processing.

FIG. 9 is a flowchart illustrating a subroutine of special game B execution processing.

FIG. 10 is a flowchart illustrating a subroutine of special game C execution processing.

FIG. 11 is a flowchart illustrating a procedure of activation processing.

FIG. 12 is a view illustrating peripheral device initialization processing.

FIG. 13 is a flowchart illustrating a subroutine of activation processing executed by a central controller.

FIG. 14 is a flowchart illustrating a subroutine of slot machine game execution processing according to a second embodiment.

FIG. 15 is a flowchart illustrating a subroutine of payout processing according to a second embodiment.

FIG. 16 is a perspective view illustrating an external appearance of a slot machine according to another embodiment.

### DESCRIPTION OF THE EMBODIMENTS

### First Embodiment

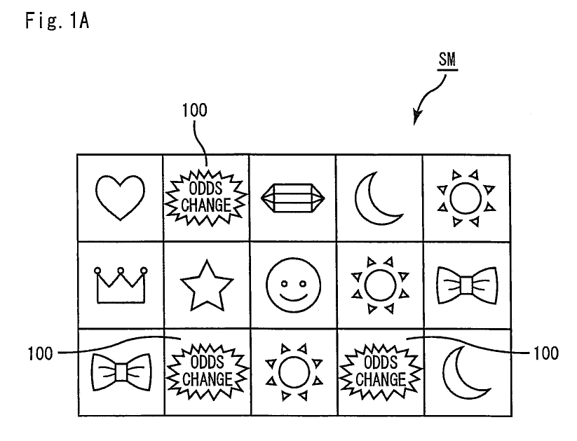

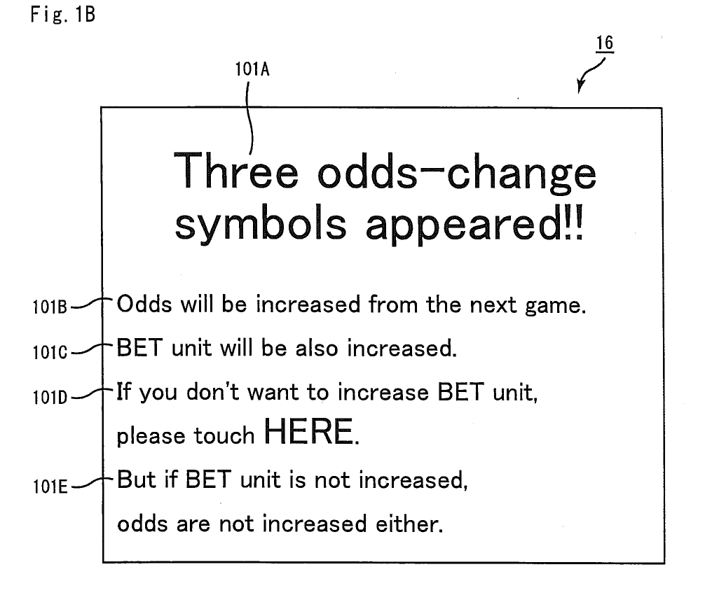

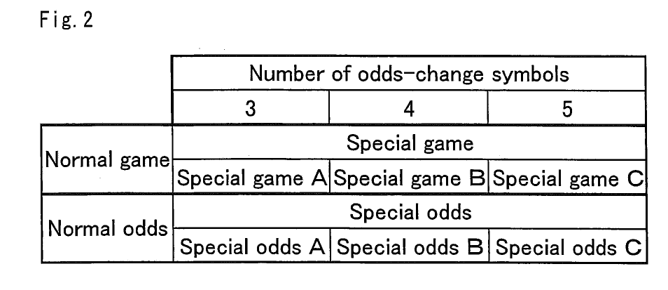

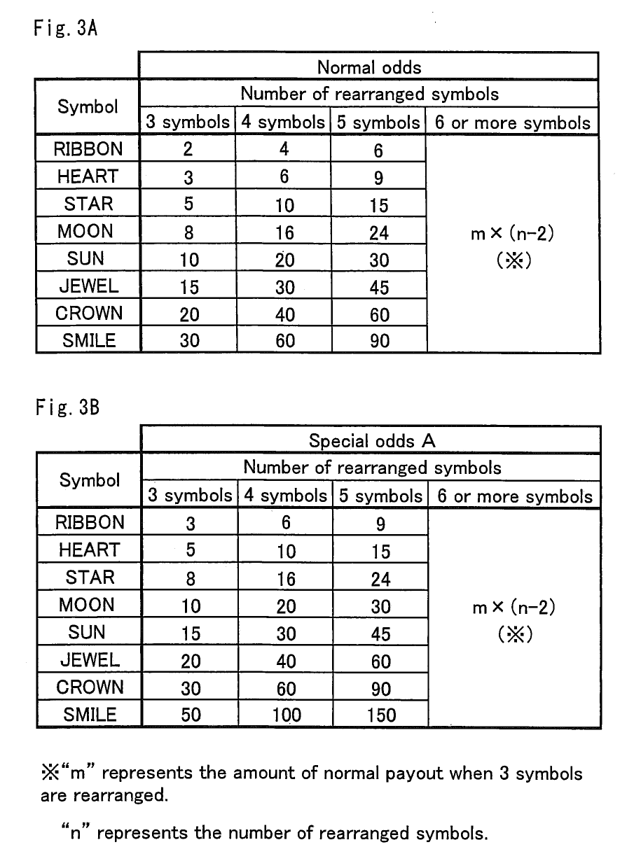

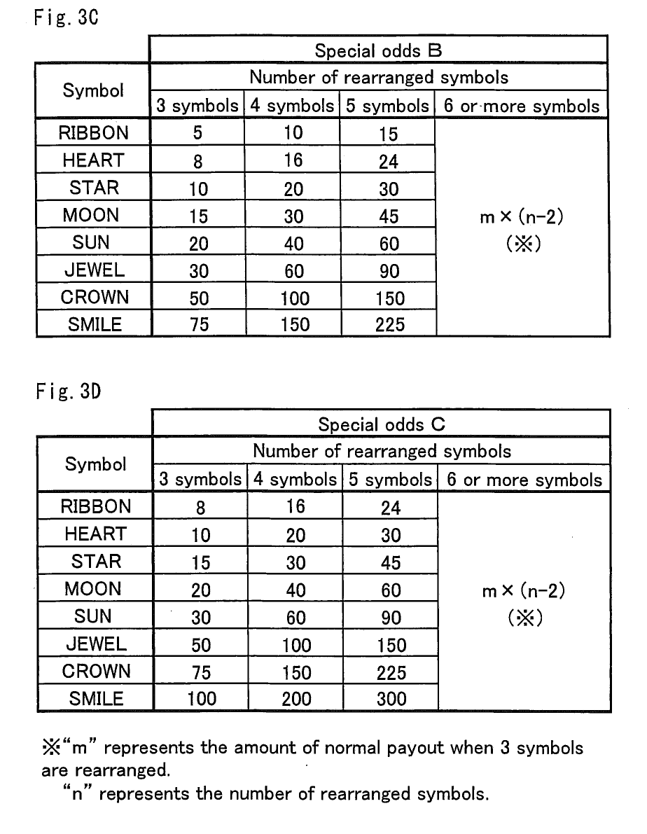

A general description of a first embodiment will be given by using FIG. 1A, FIG. 1B, FIG. 2, FIG. 3A to FIG. 3D.

FIG. 1A is a view illustrating an exemplary symbol matrix.

FIG. 1B is a view illustrating an exemplary image to be displayed to a lower image display panel.

FIG. 2 is a view illustrating a relation among a number of rearranged odds-change symbol and a special game and special odds.

FIG. 3A is a view illustrating normal odds.

FIG. 3B is a view illustrating special odds A.

FIG. 3C is a view illustrating special odds B.

FIG. 3D is a view illustrating special odds C.

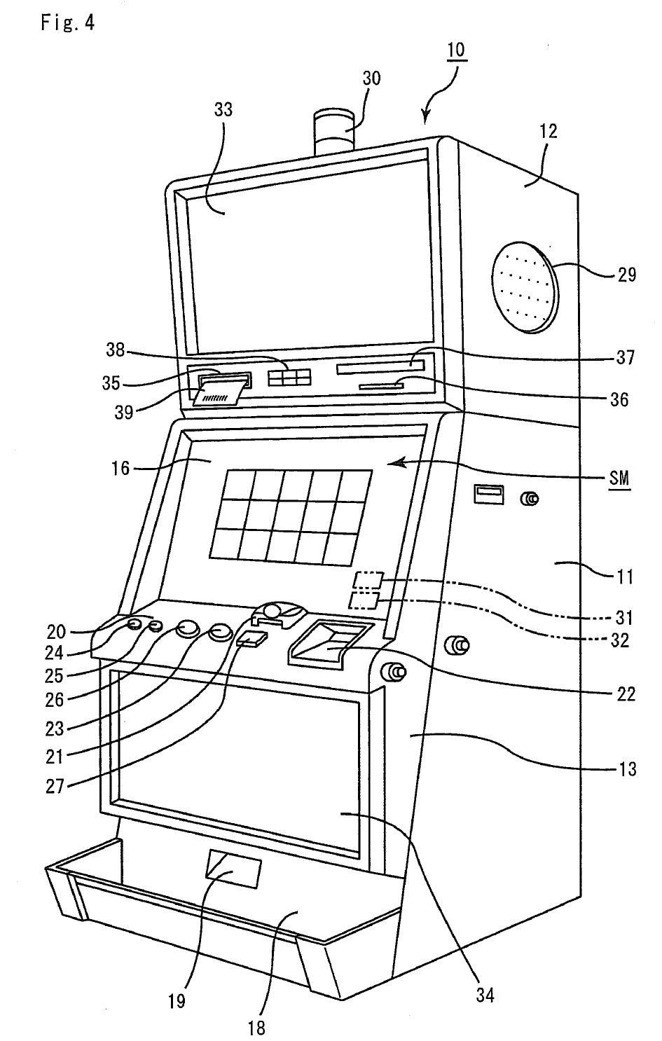

In a slot machine 10 (see FIG. 4) according to the first embodiment, an odds-change symbol 100 (see FIG. 1A) may be rearranged in a symbol matrix SM. The symbol matrix SM is displayed to a lower image display panel 16 provided in the slot machine 10. The lower image display panel 16 (see FIG. 4) corresponds to the symbol display of the present invention.

In the case that three, four, or five odds-change symbols 100 are rearranged, odds-change text images 101A to 101E as illustrated in FIG. 1B may be displayed to the lower image display panel 16.

An example in FIG. 1A shows a state that three odds-change symbols 100 are rearranged. Triggered by this, the odds-change text image 101A for notifying a player of “appearance of three odds-change symbols 100” is displayed in FIG. 1B.

The odds-change text image 101B is for notifying the player of “an increase in odds from the next game”. The odds are determined for each type and each number of the stop-displayed normal symbol, and indicate the number of coin-outs in the case that a single coin is BET (see FIGS. 3A to 3D).

The odds may be changed to different odds in the case that three odds-change symbols 100 are stop-displayed, in the case that four odds-change symbols 100 are stop-displayed, and in the case that five odds-change symbols 100 are stop-displayed (see FIG. 2).

In the case that three odds-change symbols 100 are rearranged, a special odds A may be adopted from the game subsequent to the game in which three odds-change symbols 100 are rearranged. In the case that four odds-change symbols 100 are rearranged, a special odds B may be adopted from the game subsequent to the game in which four odds-change symbols 100 are rearranged. In the case that five odds-change symbols 100 are rearranged, a special odds C may be adopted from the game subsequent to the game in which five odds-change symbols are rearranged.

The special odds A, the special odds B, and the special odds C constitute the special odds of the present invention. Further, “(the number of the rearranged odds-change symbol 100) being 3, 4, or 5” corresponds to the predetermined condition of the present invention.

As illustrated in FIG. 2, a slot machine game executed based on the special odds A is referred to as a special game A in the present description. A slot machine game executed based on the special odds B is referred to as a special game B in the present description. A slot machine game executed based on the special odds C is referred to as a special game C in the present description.

The slot machine game including the special game A, the special game B, and the special game C is referred to as a special game in the present description. The slot machine game other than the special game is referred to as a normal game in the present description. Odds in the normal game correspond to the normal odds of the present invention.

In examples illustrated in FIG. 3A to FIG. 3D, the special odds A, the special odds B, and the special odds C respectively have bigger values than the normal odds.

In the normal game, for example, in the case that three “SUN” are rearranged after two coins have been BET, 20 (=2×10) coins are paid out (see FIG. 3A).

On the other hand, for example, in the case that three odds-change symbols 100 are rearranged as illustrated in FIG. 1A, the game subsequent to the game in which three odds-change symbols 100 are rearranged is the special game A executed based on the special odds A. In the special odds A, for example, three “SUN” are rearranged after two coins have been BET, 30 (=2×15) coins are paid out (see FIG. 3B).

Here, in the first embodiment, there are eight types of the normal symbols to be rearranged in the symbol matrix SM, namely, “RIBBON”, “STAR”, “MOON”, “SUN”, “JEWEL”, “CROWN”, and “SMILE”. Further, all the normal symbols comprise so-called scatter symbols.

As above described, in the case that three, four, or five odds-change symbols 100 are rearranged, the odds may be changed, however, in the case that the player inputs a predetermined order, the odds are not changed.

The odds-change text image 101C is for notifying the player of “the BET unit increasing with increase in odds”. The BET unit is a minimum unit to BET.

In the first embodiment, the BET unit in the normal game (the minimum BET unit in the present invention) is a single coin. The BET unit in the special game A (special BET unit A)is two coins. The BET unit in the special game B (special BET unit B) is four coins. The BET unit (special BET unit C) in the special game C is eight coins. The special BET unit A, the special BET unit B, and the special BET unit C are included in the special BET unit of the present invention.

As thus described, in the slot machine 10 according to the first embodiment, the minimum BET unit in the special game is set to be larger than the minimum BET unit in the normal game.

The odds-change text image 101D is for notifying the player of “being able to increase in BET unit, if you want”. The player can input the order indicating not to increase the BET unit by touching a place on a touch panel 69 (input device of the present invention) corresponding to a text of “HERE” shown by the odds-change text image 101D.

However, in the case that the order indicating not to increase the BET unit is inputted, the odds are not increased. Namely, even three, four, or five odds-change symbols are rearranged, the odds are not changed in the case that the order indicating not to increase the BET unit has been inputted. The order indicating not to increase the BET unit corresponds to the disapproval order of change of the present invention.

There has been described the outline of the first embodiment.

Hereinafter, the first embodiment will be described in more detail.

FIG. 4 is a perspective view illustrating the external appearance of the slot machine.

In the slot machine 10, a coin, a bill, or electronic valuable information corresponding thereto is used as a game medium. However, in the present invention, a game medium is not particularly limited. Examples of the game medium may include a medal, a token, electronic money, or a ticket. It should be noted that the ticket is not particularly limited, and examples thereof include a ticket with a bar code, which will be described later.

Here, the slot machine 10 is a stand-alone type slot machine that is not connected to a network, but the present invention can also be applied to a slot machine connected to a network.

The slot machine 10 includes: a cabinet 11; a top box 12 placed on the upper side of the cabinet 11; and a main door 13 provided at the front face of the cabinet 11. The lower image display panel 16 is provided in front of the main door 13. The lower image display panel 16 includes a liquid crystal display panel and the symbol matrix SM (see FIGS. 1A) is displayed thereto. In the lower image display panel 16, there are provided a number-of-credits display section 31 and a number-of-payouts display section 32(not shown).

The number-of-credits display section 31 displays an image indicating the number of credited coins. The number-of-payouts display section 32 displays an image indicating the number of coins to be paid out as the payout.

Further, a touch panel 69, which is not shown in the figure, is provided on the front face of the lower image display panel 16, and the player can input various kinds of commands by operating the touch panel 69.

Below the lower image display panel 16, there are provided a control panel 20 comprised of a plurality of buttons 23 to 27 with each of which a command according to the game progress is inputted by the player, a coin receiving slot 21 through which a coin is accepted into the cabinet 11, and a bill validator 22.

The control panel 20 is provided with a start button 23, a change button 24, a CASHOUT button 25, a 1-BET button 26, and a maximum BET button 27. The start button 23 is used for inputting a command to start a game. The change button 24 is used for making a request of staff at a recreation facility for exchange. The CASHOUT button 25 is used for inputting a command to pay out credited coins to a coin tray 18.

The 1-BET button 26 is used for inputting a command to BET one coin on a game out of credited coins. The maximum BET button 27 is used for inputting a command to BET the maximum number (10 in the normal game, 20 in the special game A, 40 in the special game B, 80 in the special game C) of coins that can be bet on a single game out of credited coins.

The bill validator 22 not only discriminates a regular bill from a false bill, but also accepts the regular bill into the cabinet 11. It should be noted that the bill validator 22 may be configured so as to be capable of reading a later-described ticket 39 with a barcode. At the lower front face of the main door 13, namely below the control panel 20, there is provided a belly glass 34 on which a character or the like of the slot machine 10 is drawn.

At the front face of the top box 12, an upper image display panel 33 is provided. The upper image display panel 33 is provided with a liquid crystal panel to display, for example, an image representing an introduction of the contents of a game or a description of a rule of the game.

Further, the top box 12 is provided with a speaker 29. Below the upper image display panel 33, there are provided a ticket printer 35, a card reader 36, a data display 37, and a keypad 38. The ticket printer 35 prints on a ticket a barcode as coded data of the number of credits, date and time, an identification number of the slot machine 10, and the like, and outputs the ticket as a ticket 39 with a barcode. The player can make another slot machine read the ticket 39 with a barcode to play a game thereon, or can exchange the ticket 39 with a barcode with bills or the like at a predetermined place in the recreation facility (for example, a cashier in a casino).

The card reader 36 reads data from a smart card and writes data into the smart card. The smart card is a card owned by the player, and for example, data for identifying a player and data on a history of games played by the player are stored therein. Data corresponding to a coin, a bill, or a credit may be stored in the smart card. Further, in place of the smart card, a magnetic stripe card may be adopted. The data display 37 is comprised of a fluorescent display or the like, and displays, for example, data read by the card reader 36 or data inputted by the player through the keypad 38. The keypad 38 is used for inputting a command and data concerning the issue of a ticket and the like.

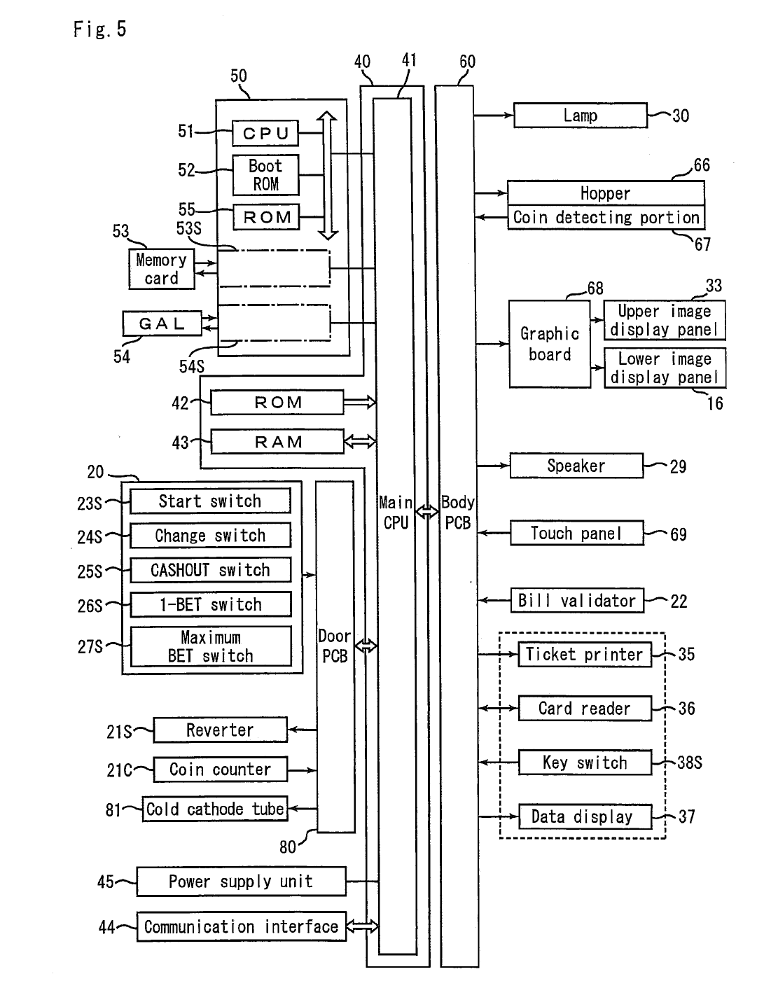

FIG. 5 is a block diagram showing an internal configuration of the slot machine shown in FIG. 4.

A gaming board 50 includes a CPU (Central Processing Unit) 51, a ROM 55, and a boot ROM 52 which are interconnected to one another via an internal bus, a card slot 53S corresponding to a memory card 53, and an IC socket 54S corresponding to a GAL (Generic Array Logic) 54.

The memory card 53 is formed from a nonvolatile memory such as CompactFlash (registered trademark) and stores game programs and game system programs. The game programs include a symbol selection program. The aforementioned symbol selection program is a program for determining the symbols (normal symbol and odds-change symbol) to be rearranged in the symbol matrix SM. The aforementioned symbol selection program includes symbol weighing data in association with a plurality of types of payout ratios (for example, 80%, 84%, 88%). The symbol weighing data is data indicating the correspondence between the respective symbols, and one or more random numbers which fall in a predetermined numerical range (0 to 255). The payout ratios are determined based on payout-ratio setting data outputted from the GAL 54 and, based on the symbol weighing data associated with the payout ratios, the symbols to be rearranged in the symbol matrix are determined.

Further, the game programs include table data (see FIG. 2) indicative of the corresponding relation between the type of the game (normal game, special game A, special game B, or special game C) and the odds (normal odds, special odds A, special odds B, or special odds C). Further, the game programs include normal odds data (see FIG. 3A) indicative of the normal odds, special odds A data (see FIG. 3B) indicative of the special odds A, special odds B data (see FIG. 3C) indicative of the special odds B, and special odds C data (see FIG. 3D) indicative of the special odds C.

Further, the card slot 53S is configured so as to allow the memory card 53 to be inserted there into or ejected therefrom, and is connected to a mother board 40 via an IDE bus. Thus, the memory card 53 can be ejected from the card slot 53S, and then another game program is written onto the memory card 53, and the memory card 53 can be inserted into the card slot 53S, to change the type and contents of a game to be played on the slot machine 10. The game program includes a program associated with the progress of a game. The game program also includes image data and sound data to be outputted during the game. The image data includes image data indicating a symbol matrix.

The GAL 54 is a type of PLD having a fixed OR array structure. The GAL 54 includes plural input ports and plural output ports and, when predetermined data is inputted to an input port, the GAL 54 outputs data corresponding to the aforementioned data from an output port. The data outputted from this output port is the aforementioned payout-ratio setting data.

Further, the IC socket 54S is configured to allow the GAL 54 to be attached thereto and detached therefrom and is connected to the mother board 40 through a PCI bus. Accordingly, the GAL 54 can be replaced with another GAL 54 to change the payout-ratio setting data.

A CPU 51, a ROM 55 and a boot ROM 52 interconnected to one another via an internal bus are connected to the mother board 40 by PCI bus. The PCI bus supplies power to the gaming board 50 from the mother board 40, as well as transmitting a signal between the mother board 40 and the gaming board 50. The ROM 55 stores country identification information and an authentication program. The boot Rom 52 stores an auxiliary authentication program and a program (boot code) to be used by the CPU 51 for activating the auxiliary authentication program, and the like.

The authentication program is a program (falsification check program) for authenticating a game program and a game system program. The authentication program is written along a procedure (authentication procedure) for checking and proving that a game program and a game system program to be subject to authentication loading processing have not been falsified, namely authenticating the game program and the game system program. The auxiliary authentication program is a program for authenticating the above-mentioned authentication program. The auxiliary authentication program is written along a procedure (authentication procedure) for proving that an authentication program to be subject to the authentication processing has not been falsified, namely, authenticating the authentication program.

The mother board 40 is constructed with a general-purpose mother board commercially available (a printed circuit board on which basic parts of a personal computer are mounted) and includes a main CPU 41, ROM (Read Only Memory) 42 and RAM (Random Access Memory) 43. The mother board 40 is the controller of the present invention.

ROM 42 is constituted of a memory device such as a flash memory and stores thereon a program such as BIOS (Basic Input/Output System) executed by the main CPU 41 and permanent data. When BIOS is executed by the main CPU 41, not only is initialization processing for predetermined peripheral devices conducted, but a capture processing for the game program and game system program stored on the memory card 53 is also started via the gaming board 50. In the present invention, contents of ROM 42 may be rewritable or not rewritable.

RAM 43 stores data and a program used at the time of operation of the main CPU 41, and various flags. RAM 43 can also store the authentication program read through the gaming board 50, the game program, and the game system program. RAM 43 further stores data on the number of credits, the number of coins-in or coins-out for one game, and the like.

Further, in the RAM 43, a number-of-special-game-A storage area, a number-of-special-game-B storage area, and the number-of-special-game-C storage area are provided. The number-of-special-game-A storage area stores data indicating the remaining number of the special game A. The number-of-special-game-B storage area stores data indicating the remaining number of the special game B. The number-of-special-game-C storage area stores data indicating the remaining number of the special game C.

To the mother board 40, a body PCB (Printed Circuit Board) 60 and a door PCB 80, which will be described later, are connected through respective USBs. Further, the mother board 40 is connected with a power supply unit 45. When the power is supplied from the power unit 45 to the mother board 40, the main CPU 41 of the mother board 40 is activated and the power is supplied to the gaming board 50 through the PCI bus so that the CPU 51 is activated.

The body PCB 60 and the door PCB 80 are connected with equipment and devices that generate input signals to be inputted to the main CPU 41, and equipment and devices operations of which are controlled by control signals outputted from the main CPU 41. The main CPU 41 executes a game program stored in the RAM 43 based on an input signal inputted to the main CPU 41, thereby executes the predetermined arithmetic processing and stores a result thereof in the RAM 43, or transmits a control signal to each of the equipment and devices as processing for controlling each of the equipment and devices.

To the body PCB 60, there are connected a lamp 30, a hopper 66, a coin detecting portion 67, a graphic board 68, a speaker 29, a touch panel 69, a bill validator 22, a ticket printer 35, a card reader 36, a key switch 38S, and a data display 37. The lamp 30 lights up in a predetermined pattern based on a control signal outputted from the main CPU 41.

The hopper 66 is installed inside the cabinet 11 and pays out a predetermined number of coins from the coin payout exit 19 to the coin tray 18, based on a control signal outputted from the main CPU 41. The coin detecting portion 67 is provided inside the coin payout exit 19, and outputs an input signal to the main CPU 41 when detecting a payout of a predetermined number of coins from the coin payout exit 19.

The graphic board 68 controls, based on a control signal outputted from the main CPU 41, an image display to the upper image display panel 33 and the lower image display panel 16. The number of credits stored in RAM 43 is displayed to the number-of-credits display section 31 (not shown) of the lower image display panel 16. The number of coins-out is displayed to the number-of-payouts display section 32 (not shown) of the lower image display panel 16. The graphic board 68 is equipped with VDP (Video Display Processor) which generates image data based on a control signal outputted from the main CPU 41 and a video RAM which temporarily stores image data generated by VDP, and of the like equipments. It should be noted that image data used in generating image data with VDP is contained in a game program read from the memory card 53 and stored in RAM 43.

The bill validator 22 not only discriminates a regular bill from a false bill, but also accepts the regular bill into the cabinet 11. When accepting a regular bill, the bill validator 22 outputs an input signal to the main CPU 41, based on the face amount of the bill. The main CPU 41 stores, in the RAM 43, the number of credits according to the face amount of the bill transmitted with the input signal.

The ticket printer 35 prints on a ticket, based on a control signal outputted from the main CPU 41, a barcode formed by encoding data such as the number of credits, date and time, an identification number of the slot machine 10, and of the like data stored in the RAM 43, and outputs the ticket as a ticket 39 with a barcode.

The card reader 36 reads data from a smart card and transmits the data to the main CPU 41 or writes data into the smart card based on a control signal from the main CPU 41. The key switch 38S is provided on the keypad 38, and outputs a predetermined input signal to the main CPU 41 when the keypad 38 is operated by the player. The data display 37 displays, based on a control signal outputted from the main CPU 41, data read by the card reader 36 or data inputted by the player through the keypad 38.

To the door PCB 80, there are connected a control panel 20, a reverter 21S, a coin counter 21C, and a cold cathode tube 81. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. Each of the switches 23S to 27S outputs an input signal to the main CPU 41 when each of the buttons 23 to 27 corresponding thereto is operated by the player.

The coin counter 21C is provided inside the coin receiving slot 21 and discriminates a regular coin from a false coin inserted into the coin receiving slot 21 by the player. Coins other than regular coins are discharged from the coin payout exit 19. When the coin counter 21C detects a regular coin, the coin counter 21C outputs an input signal to the main CPU 41.

The reverter 21S operates based on a control signal outputted from the main CPU 41, and distributes a coin identified by the coin counter 21C as a regular coin into a cash box (not shown) or the hopper 66, which are disposed in the slot machine 10. Specifically, when the hopper 66 is filled with coins, a regular coin is distributed into the cash box by the reverter 21S. On the other hand, when the hopper 66 is not filled with coins, the regular coin is distributed into the hopper 66. The cold cathode tube 81 functions as a backlight installed on the rear face side of the lower image display panel 16 and the upper image display panel 33, and lights up based on a control signal to be outputted from the main CPU 41.

Next, processing executed in the slot machine 10 will be described.

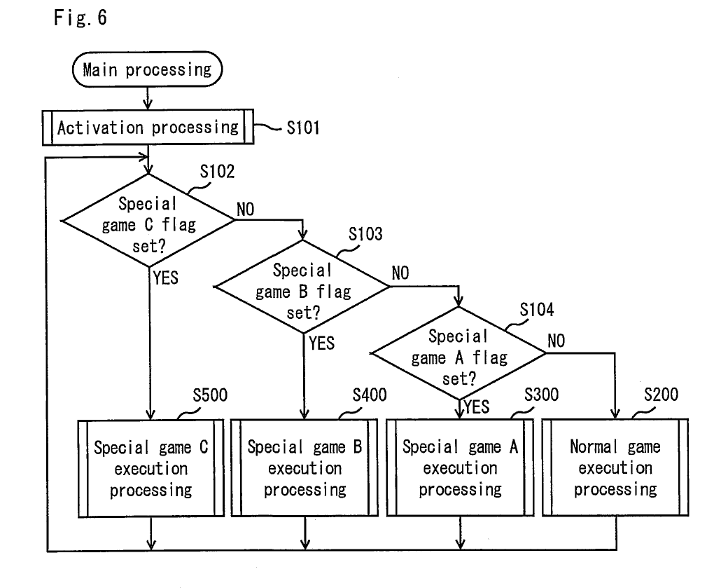

FIG. 6 is a flowchart illustrating main processing executed in the slot machine 10 according to a first embodiment.

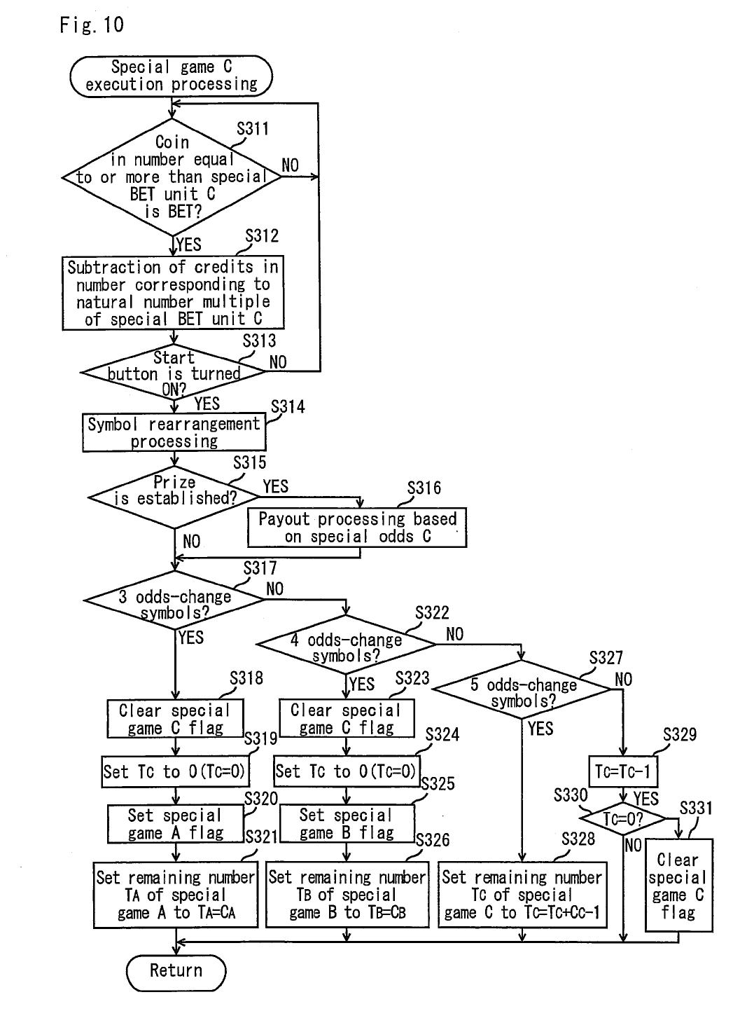

First, in the slot machine 10, activation processing is executed (step S101). The activation processing will be specifically described later by using FIG. 10 to FIG. 12.

After the activation processing, the main CPU 41 executes processing of addition of the number of credits stored in the RAM 43 as an interrupt processing, on receiving a detection signal outputted from the coin counter 21C when the coin inserted into the coin receiving slot 21 is detected by the coin counter 21.

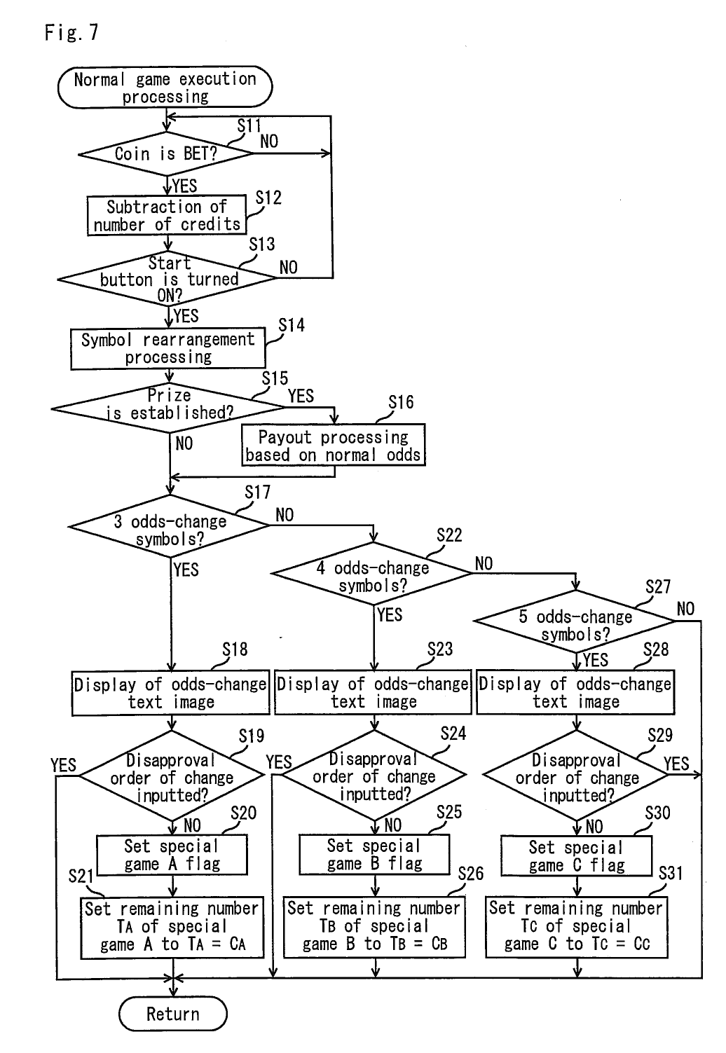

After the processing of step S101, the main CPU 41 determines whether or not s special game C flag is set (step S102). The special game C flag is a flag to be set as triggered by the rearrangement of five odds-change symbols 100, and is a flag indicating that it is currently the special game C period (see step S30 in FIG. 7).

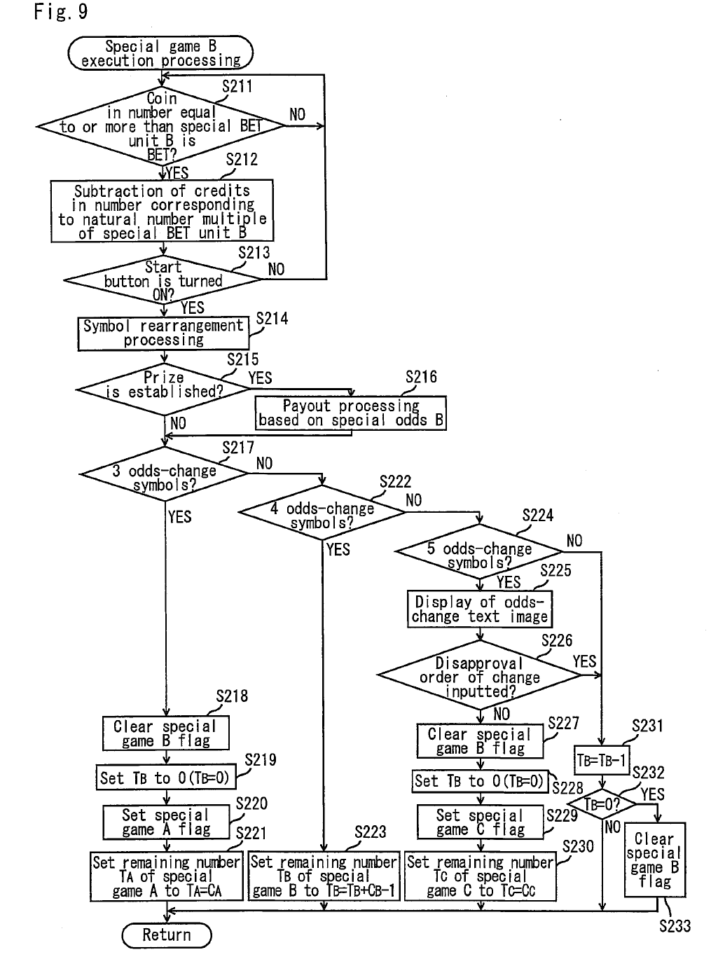

When determining that the special game C flag is set, the main CPU 41 executes special game C execution processing (step S500). The special game C execution processing will be specifically described later by using FIG. 9. After executing the processing of step S500, the main CPU 41 returns the processing to step S102.

When determining that the special game C flag is not set, the main CPU 41 determines whether or not a special game B flag is set (step S103). The special game B flag is a flag to be set as triggered by the rearrangement of four odds-change symbols 100, and is a flag indicating that it is currently the special game B period (see step S25 in FIG. 7).

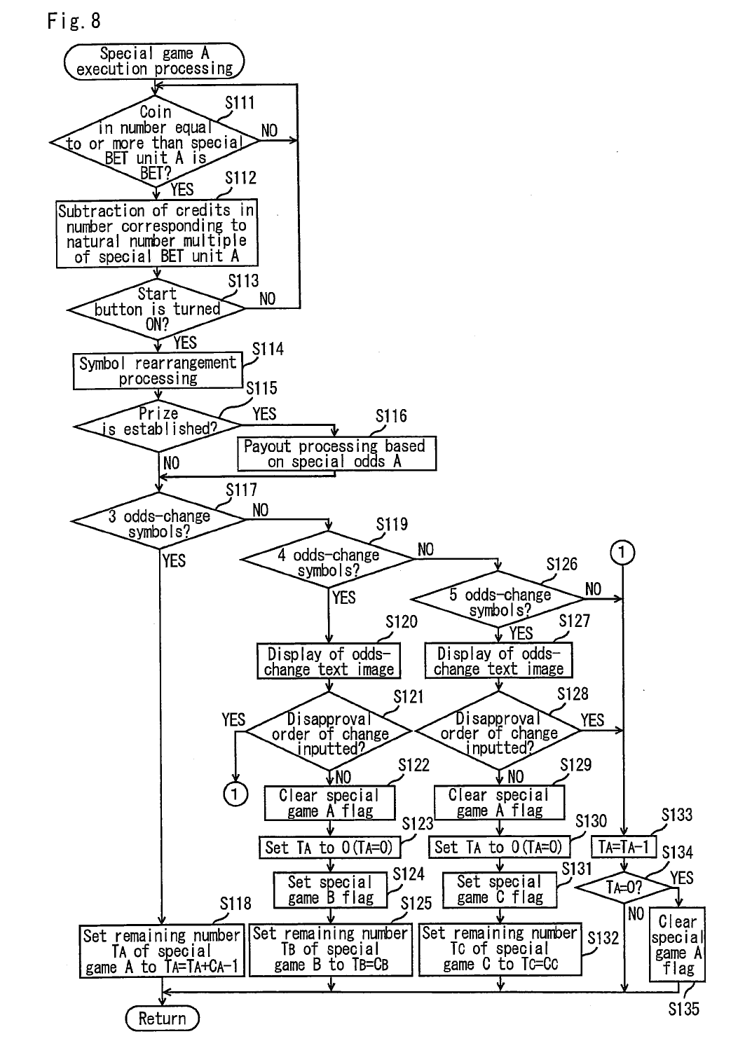

When determining that the special game B flag is set, the main CPU 41 executes special game B execution processing (step S400). The special game B execution processing will be specifically described later by using FIG. 8. After executing the processing of step S400, the main CPU 41 returns the processing to step S102.

When determining that the special game B flag is not set, the main CPU 41 determines whether or not a special game A flag is set (step S104). The special game A flag is a flag to be set as triggered by the rearrangement of three odds-change symbols, and is a flag indicating that it is currently the special game A period (see step S20 in FIG. 7).

When determining that the special game A flag is set, the main CPU 41 executes special game A execution processing (step S300). The special game A execution processing will be specifically described later by using FIG. 7. After executing the processing of step S300, the main CPU 41 returns the processing to step S102.

When determining that the special game A flag is not set, the main CPU 41 executes normal game execution processing (step S200). The normal game execution processing will be specifically described later by using FIG. 6. After executing the processing of step S200, the main CPU 41 returns the processing to step S102.

Hereinafter, slot machine game execution processing (normal game execution processing, special game A execution processing, special game B execution processing, and special game C execution processing) executed in the slot machine 10 will be described.

The main CPU 41 reads a game program and executes the game program to progress a slot machine game.

FIG. 7 is a flowchart illustrating a subroutine of normal game execution processing.

First, the main CPU 41 determines whether or not a coin has been BET (step S11). In the processing, the main CPU 41 determines whether or not to have received an input signal outputted from the 1-BET switch 26S when the 1-BET button 26 is operated or an input signal outputted from the maximum BET switch 27S when the maximum BET button 27 is operated. When determining that a coin has not been BET, the main CPU 41 returns the processing to step S11.

On the other hand, when determining that a coin has been BET in step S11, the main CPU 41 executes processing for making a subtraction from the number of credits stored in the RAM 43, according to the number of BET coins (step S12). It should be noted that, when the number of BET coins is larger than the number of credits stored in the RAM 43, the main CPU 41 does not execute the processing for making a subtraction from the number of credits stored in the RAM 43, and returns the processing to step S11. When the number of BET coins exceeds an upper limit of the number of coins that can be BET on a single game (10 in the normal game), the main CPU 41 does not execute the processing for making a subtraction from the number of credits stored in the RAM 43, and the processing is proceeded to step S13.

Next, the main CPU 41 determines whether or not the start button 23 has been turned on (step S13). In the processing, the main CPU 41 determines whether or not to have received an input signal outputted from the start switch 23S when the start button 23 is pressed.

When determining that the start button 23 has not been turned ON, the main CPU 41 returns the processing to step S11. It should be noted that, when the start button 23 is not turned ON (for example, when a command to end the game is inputted without pressing the start button 23), the main CPU 41 cancels a result of the subtraction obtained in step S12.

On the other hand, when determining in step S13 that the start button 23 has been turned ON, the main CPU 41 executes symbol rearrangement processing (step S14).

In the processing, at first, the main CPU 41 starts scroll-display of the symbols (normal symbol and odds-change symbol) in the symbol matrix SM. Then, the main CPU 41 executes the above-mentioned symbol selection program, determines symbols to be rearranged, and rearranges the symbols in the symbol matrix SM.

Next, the main CPU 41 determines whether or not a prize is established (step S17). Here, the establishment of the prize refers to the rearrangement of three or more normal symbols of at least one type, out of “RIBBON”, “HEART”, “STAR”, “MOON”, “SUN”, “JEWEL”, “CROWN”, and “SMILE”, in the symbol matrix SM (see FIG. 3). In the processing, the main CPU 41 counts the number of normal symbol for each type, with regard to the rearranged symbols in step S14. Then, the main CPU 41 determines whether or not the counted number is equal to or more than three.

When determining that the prize has been established, the main CPU 41 executes processing according to payout of the coin (step S16). In the processing, the main CPU 41 determines the amount of payout based on the number of rearranged symbols with reference to the normal odds data (see FIG. 3A) stored in the RAM 43.

In the case of accumulating the coin, the main CPU 41 executes processing for adding an amount of credits corresponding to the determined amount of payout. On the other hand, in the case of paying out coins, the main CPU 41 transmits a control signal to the hopper 66 in order to pay out the coin in amount corresponding to the determined amount of payout.

When determining that the prize has not been established in step S15 or after executing the processing of step S16, the main CPU 41 determines whether or not the number of the odds-change symbol rearranged in step S14 is three (step S17)

When determining that the number of the odds-change symbol is three, the main CPU 41 displays the odds-change text images 101A to 101E (see FIG. 1B) to the lower image display panel 16 (step S18). At this time, triggered by the number of the odds-change symbol being three, the main CPU 41 displays the odds-change text image 101A corresponding to “Three odds-change symbols appeared!!” to the lower image display panel 16.

Then, the main CPU 41 accepts the input of the order indicating not to increase the BET unit (disapproval order of change). Thereafter, the main CPU 41 determines whether or not the disapproval order of the change has been inputted (step S19) In the processing, the main CPU 41 determines whether or not to have received a signal outputted as triggered by the touch of the place on the touch panel 69 corresponding to the text of “HERE” shown by the odds-change text image 101D, in a predetermined time.

When determining that the disapproval order of the change has not been inputted, the main CPU 41 sets the special game A flag (step S20).

Then, the main CPU 41 sets the remaining number T_{A} of the special game A to T_{A}=C_{A} (C_{A}=10, in the first embodiment) in the number-of-special-game-A storage area in the RAM 43 (step S21).

When determining that the disapproval order of the change has been inputted in step S19 or after executing the processing of step S21, the main CPU 41 terminates the present subroutine.

When determining that the number of the odds-change symbol is not three in step S17, the main CPU 41 determines whether or not the number of the odds-change symbol is four (step S22). When determining that the number of the odds-change symbol is four, the main CPU 41 displays the odds-change text images 101A to 101E (see FIG. 1B) to the lower image display panel 16 (step S23). At this time, triggered by the number of the odds-change symbol being four, the main CPU 41 displays the odds-change text image 101A corresponding to “Four odds-change symbols appeared!!” to the lower image display panel 16.

Then, the main CPU 41 accepts the input of the order indicating not to increase the BET unit (disapproval order of change). Thereafter, the main CPU 41 determines whether or not the disapproval order of change has been inputted (step S19). In the processing, the main CPU 41 determines whether or not to have received a signal outputted as triggered by the touch of the place on the touch panel 69 corresponding to the text of “HERE” shown by the odds-change text image 101D.

When determining that the disapproval order of change has not been inputted, the main CPU 41 sets the special game B flag (step S25).

Then, the main CPU 41 sets the remaining number T_{B} of the special game B to T_{B}=C_{B} (C_{B}=15, in the first embodiment) in the number-of-special-game-B storage area in the RAM 43 (step S26).

When determining that the disapproval order of change has been inputted in step S24 or after executing the processing of step S26, the main CPU 41 terminates the present subroutine.

When determining that the number of the odds-change symbol is not four instep S22, the main CPU 41 determines whether or not the number of the odds-change symbol is five (step S27). When determining that the number of the odds-change symbol is five, the main CPU 41 displays the odds-change text images 101A to 101E (see FIG. 1B) to the lower image display panel 16 (step S28). At this time, triggered by the number of the odds-change symbol being five, the main CPU 41 displays the odds-change text image 101A corresponding to “Five odds-change symbols appeared!!” to the lower image display panel 16.

Then, the main CPU 41 accepts the input of the order indicating not to increase the BET unit (disapproval order of change). Thereafter, the main CPU 41 determines whether or not the disapproval order of the change has been inputted (step S29) In the processing, the main CPU 41 determines whether or not to have received a signal outputted as triggered by the touch of the place on the touch panel 69 corresponding to the text of “HERE” shown by the odds-change text image 101D.

When determining that the disapproval order of the change has not been inputted, the main CPU 41 sets the special game C flag (step S30).

Then, the main CPU 41 sets the remaining number T_{C} of the special game C to T_{C}=C_{C} (C_{C}=30, in the first embodiment) in the number-of-special-game-C storage area in the RAM 43 (step S31).

When determining that the number of the odds-change symbol is not four in step S27 or determining that the disapproval order of change has been inputted in step S24 or after executing the processing of step S31, the main CPU 41 terminates the present subroutine.

The normal game execution processing (see step S200 in FIG. 6) has been described by using FIG. 7.

Next, the special game A execution processing (see step S300 in FIG. 6) will be described by using FIG. 8.

FIG. 8 is a flowchart illustrating a subroutine of special game A execution processing.

First, the main CPU 41 determines whether or not the coin in number equal to or more than the special BET unit A (two coins, in the first embodiment) have been BET (step S111). In the processing, the main CPU 41 determines whether or not to have received an input signal outputted from the 1-BET switch 26S when the 1-BET button 26 is operated or an input signal outputted from the maximum BET switch 27S when the maximum-BET button 27 is operated.

When determining that the input signal outputted from the 1-BET switch 26S has been received, the main CPU 41 determines that one coin has been BET. Further, when determining that the input signal outputted from the maximum BET switch 27S has been received, the main CPU 41 determines that 20 coins have been BET.

When determining that two or more coins have not been BET, the main CPU 41 returns the processing to step S111.

As above described, in the first embodiment, there has been described the case that the main CPU 41 determines that one coin (minimum BET unit) has been BET when receiving the input signal outputted from the 1-BET switch 26S in the special game period, in the same manner as in the normal game period. However, in the present invention, a main CPU may be set to determine that the game medium in amount corresponding to the special BET unit when receiving an input signal outputted from a 10BET switch in the special game period.

On the other hand, when determining that two or more coins have been BET in step S111, the main CPU 41 execute processing of subtraction of the number of credits stored in the RAM 43 according to the number M of the BET coin (step S112). In the processing, the main CPU 41 subtracts the number of credits corresponding to the coins in number of 2N (=N×2) (N is the maximum integer satisfying 2N≦M).

Here, in the case that the number of BET coins is larger than the number of credits stored in the RAM 43, the main CPU 41 returns the processing to step S111 without executing the processing of subtraction of the number of credits stored in the RAM 43. Further, in the case that the number of BET coins exceeds the upper limit (20, in the special game A) that can be BET in one game, the main CPU 41 proceeds the processing to step S113 without executing the processing of subtraction of the number of credits stored in the RAM 43.

Next, the main CPU 41 executes processing of step S113 to step S117, and the processing is virtually the same processing as the processing of step S13 to step S17. Here, only a part different from the processing of step S13 to step S17 will be described.

In step S16 in FIG. 7, there has been described the case that the main CPU 41 refers to the normal odds data (see FIG. 3A) stored in the RAM 43 when determining the amount of payout. On the other hand, in step S116 in FIG. 8, the main CPU 41 refers to the special odds A data (see FIG. 3B) stored in the RAM 43 when determining the amount of payout.

When determining the number of the odds-change symbol is three in step S117, the main CPU 41 sets the remaining number T_{A} of the special game A to T_{A}=T_{A}+C_{A}−1 (C_{A}=10, in the first embodiment) in the number-of-special-game-A storage area in the RAM 43 (step S118).

After executing the processing of step S118, the main CPU 41 terminates the present subroutine.

When determining that the number of the odds-change symbol is not three in step S117, the main CPU 41 executes processing of step S119 to step S121. The processing is virtually the same processing as the processing of step S22 to step S24 in FIG. 7 and the description thereof is omitted here.

When determining that the disapproval order of change has not been inputted in step S121, the main CPU 41 clears the special game A flag (step S122). Then, the main CPU 41 sets the remaining number T_{A} of the special game A to T_{A}=0 in the number-of-special-game-A storage area (step S123).

Next, the main CPU 41 sets the special game B flag (step S124). Then, the main CPU 41 sets the remaining number T_{B} of the special game B to T_{B}=C_{B} (in the first embodiment, C_{B}=15) in the number-of-special-game-B storage area in the RAM 43 (step S125).

After executing the processing of step S125, the main CPU 41 terminates the present subroutine.

When determining that the number of the odds-change symbol is not four in step S119, the main CPU 41 executes processing of step S126 to step S128. The processing is virtually the same processing as the processing of step S27 to step S29 in FIG. 7 and the description thereof is omitted here.

When determining that the disapproval order of the change has not been inputted in step S121, the main CPU 41 clears the special game A flag (step S129). Then, the main CPU 41 sets the remaining number T_{A} of the special game A to T_{A}=0 in the number-of-special-game-A storage area (step S130).

Next, the main CPU 41 sets the special game C flag (step S131). Then, the main CPU 41 sets the remaining number T_{C} of the special game C to T_{C}=C_{C} (C_{C}=30, in the first embodiment) in the number-of-special-game-C storage area in the RAM 43 (step S132).

After executing the processing of step S132, the main CPU 41 terminates the present subroutine.

When determining that the number of the odds-change symbol is not five in step S126, or when determining that the disapproval order of the change has been inputted in step S121 or in step S128, the main CPU 41 sets the remaining number T_{A} of the special game A to T_{A}=T_{A}−1 in the number-of-special-game-A storage area in the RAM 43 (step S133).

Next, the main CPU 41 determines whether or not the remaining number T_{A} of the special game A is T_{A}=0 (step S134). When determining that the remaining number T_{A} of the special game A is T_{A}=0, the main CPU 41 clears the special game A flag (step S135).

When determining that the remaining number T_{A} of the special game A is not T_{A}=0, or after executing the processing of step S135, the main CPU 41 terminates the present subroutine.

There has been described the special game A execution processing (see step S300 in FIG. 6) by using FIG. 8.

As above described, the slot machine 10 according to the first embodiment is configured such that the remaining number of the special game A is increased in the case that three odds-change symbol are rearranged in the special game A (see step S117 to step S118).

Further, the slot machine 10 according to the first embodiment is configured such that, in the case that four odds-change symbols are rearranged in the special game A, the special game A is terminated and the special game B is executed from the next game, on condition that the disapproval order of the change has not been inputted (see step S119 to step S125).

Furthermore, the slot machine 10 according to the first embodiment is configured such that, in the case that five odds-change symbols are rearranged in the special game A, the special game A is terminated and the special game C is executed from the next game, on condition that the disapproval order of change has not been inputted (see step S126 to step S132).

Next, the special game B execution processing (see step S400 in FIG. 6) will be described by using FIG. 9.

FIG. 9 is a flowchart illustrating a subroutine of special game B execution processing.

First, the main CPU 41 executes the processing of step S211 to step S217, and the processing is virtually the same processing as the processing of step S111 to step S117 in FIG. 8. Here, only a part different from the processing of step S111 to step S117 in FIG. 8 will be described.

In step S111 in FIG. 8, there has been described the case that the main CPU 41 determines whether or not the coins in number equal to or more than the special BET unit A (two, in the first embodiment) have been BET. On the other hand, in step S211 in FIG. 9, the main CPU 41 determines whether or not the coins in number equal to or more than the special BET unit B (four coins, in the first embodiment) have been BET.

Further, in step S111 in FIG. 8, there has been described the case that the main CPU 41 determines that 20 coins have been BET when determining to have received the input signal outputted from the maximum BET switch 27S. On the other hand, in step S211 in FIG. 9, the main CPU 41 determines that 40 coins have been BET when determining to have received the input signal outputted from the maximum BET switch 27S.

In step S112 in FIG. 8, there has been described the case that the main CPU 41 subtracts the number of credits corresponding to the coins in number of 2N (=N×2) (N is the maximum integer satisfying 2N≦M). On the other hand, in step S212 in FIG. 9, the main CPU 41 subtracts the number of credits corresponding to the coins in number of 4N (=N×4) (N is the maximum integer satisfying 4N≦M).

In step S116 in FIG. 8, there has been described the case that the main CPU 41 refers to the special odds A data (see FIG. 3B) stored in the RAM 43 when determining the amount of payout. On the other hand, in step S216 in FIG. 9, the main CPU 41 refers to the special odds B data (see FIG. 3C) stored in the RAM 43 when determining the amount of payout.

Next, when determining that the number of the odds-change symbol is three in step S217, the main CPU 41 clears the special odds B flag (step S218) and sets the remaining number T_{B} of the special game B to T_{B}=0 in the number-of-special-game-B storage area in the RAM 43 (step S219) in the number-of-special-game-A storage area in the RAM 43.

Next, the main CPU 41 sets the special game A flag (step S220). Then, the main CPU 41 set the remaining number T_{A} of the special game A to T_{A}=C_{A} (C_{A}=10, in the first embodiment) (step S221).

After executing the processing of step S221, the main CPU 41 terminates the present subroutine.

When determining that the number of the odds-change symbol is not three in step S217, the main CPU 41 determines whether or not the number of the odds-change symbol is four (step S222).

When determining that the number of the odds-change symbol is four, the main CPU 41 sets the remaining number T_{B} of the special game B to T_{B}=T_{B}+C_{B}−1 (C_{B}=15, in the first embodiment) in the number-of-special-game-B storage area in the RAM 43 (step S223).

After executing the processing of step S223, the main CPU 41 terminates the present subroutine.

When determining that the number of the odds-change symbol is not four in step S222, the main CPU 41 executes the processing of step S224 to step S226, and the processing is virtually the same processing as the processing of step S27 to step S29 in FIG. 7. Therefore, the description thereof is omitted here.

When determining that the disapproval order of the change has not been inputted in step S226, the main CPU 41 clears the special game B flag (step S227) and sets the remaining number T_{B} of the special game B to T_{B}=0 in the number-of-special-game-B storage area in the RAM 43(step S228).

Next, the main CPU 41 sets the special game C flag (step S229). Then, the main CPU 41 sets the remaining number T_{C} of the special game C to T_{C}=C_{C} (C_{C}=30, in the first embodiment) in the number-of-special-game-C storage area in the RAM 43 (step S230).

After executing the processing of step S230, the main CPU 41 terminates the present subroutine.

When determining that the number of the odds-change symbol is not five in step S224, or when determining that the disapproval order of the change has been inputted in step S226, the main CPU 41 sets the remaining number T_{B} of the special game B to T_{B}=T_{B}−1 in the number-of-special-game-B storage area in the RAM 43(step S231).

Next, the main CPU 41 determines whether or not the remaining number T_{B} of the special game B is T_{B}=0 (step S232). When determining that the remaining number T_{B} of the special game B is T_{B}=0, the main CPU 41 clears the special game B flag (step S233).

When determining that the remaining number T_{B} of the special game B is not T_{B}=0 in step S232, or after executing the processing of step S233, the main CPU 41 terminates the present subroutine.

There has been described the special game B execution processing (see step S400 in FIG. 6) by using FIG. 9.

As above described, the slot machine 10 according to the first embodiment is configured such that, when three odds-change symbols are rearranged in the special game B, the special game B is terminated and the special game A is executed from the next game (see step S217 to step S221). In this case, the player cannot input the disapproval order of the change.

Further, the slot machine 10 according to the first embodiment is configured such that the remaining number of the special game B is increased when four odds-change symbols are rearranged in the special game B (see step S222 to step S223).

Furthermore, the slot machine 10 according to the first embodiment is configured such that, when five odds-change symbols are rearranged in the special game B, the special game B is terminated and the special game C is executed from the next game on condition that the disapproval order of the change has not been inputted (see step S224 to step S230).

Next, the special game C execution processing (see step S500 in FIG. 6) will be described by using FIG. 10.

FIG. 10 is a flowchart illustrating a subroutine of special game C execution processing.

First, the main CPU 41 executes the processing of step S311 to step S317, and the processing is virtually the same processing as the processing of step S111 to step S117 in FIG. 8. Here, only a part different from the processing of step S111 to step S117 in FIG. 8 will be described.

In step S111 in FIG. 8, there has been described the case that the main CPU 41 determines whether or not the coins in number equal to or more than the special BET unit A (two coins, in the first embodiment) have been BET. On the other hand, in step S311 in FIG. 10, the main CPU 41 determines whether or not the coins in number equal to or more than the special BET unit C (eight coins, in the first embodiment) have been BET.

Further, in step S111 in FIG. 8, there has been described the case that the main CPU 41 determines that 40 coins have been BET when determining to have received the input signal outputted from the maximum BET switch 27S. On the other hand, in step S311 in FIG. 10, the main CPU 41 determines that 80 coins have been BET when determining to have received the input signal outputted from the maximum BET switch 27S.

In step S112 in FIG. 8, there has been described the case that the main CPU 41 subtracts the number of credits corresponding to the coins in number of 2N (=N×2) (N is the maximum integer satisfying 2N≦M). On the other hand, in step S312 in FIG. 10, the main CPU 41 subtracts the number of credits corresponding to the coins in number of 8N (=N×8) (N is the maximum integer satisfying 8N≦M).

In step S116 in FIG. 8, there has been described the case that the main CPU 41 refers to the special odds A data (see FIG. 3B) stored in the RAM 43 when determining the amount of payout. On the other hand, in step S316 in FIG. 10, the main CPU 41 refers to the special odds C data (see FIG. 3D) stored in the RAM 43 when determining the amount of payout.

Next, when determining that the number of the odds-change symbol is three in step S317, the main CPU 41 clears the special odds C flag (step S318) and sets the remaining number T_{C} of the special game C to T_{C}=0 in the number-of-special-game-C storage area in the RAM 43 (step S319).

Next, the main CPU 41 sets the special game A flag (step S320). Then, the main CPU 41 set the remaining number T_{A} Of the special game A to T_{A}=C_{A} (C_{A}=10, in the first embodiment) (step S321).

After executing the processing of step S321, the main CPU 41 terminates the present subroutine.

When determining that the number of the odds-change symbol is not three in step S317, the main CPU 41 determines whether or not the number of the odds-change symbol is four (step S322)

When determining that the number of the odds-change symbol is four, the main CPU 41 clears the special game C flag (step S323) and sets the remaining number T_{C} of the special game C to T_{C}=0 in the number-of-special-game-C storage area in the RAM 43(step S324).

Then, the main CPU 41 sets the special game B flag (step S325). The main CPU 41 sets the remaining number T_{B} of the special game B to T_{B}=C_{B} (C_{B}=15, in the first embodiment) in the number-of-special-game-B storage area in the RAM 43 (step S326).

After executing the processing in step S326, the main CPU 41 terminates the present subroutine.

When determining that the number of the odds-change symbol is not four in step S322, the main CPU 41 determines whether or not the number of the odds-change symbol is five (step S327).

When determining that the number of the odds-change symbol is five, the main CPU 41 sets the remaining number T_{C} of the special game C to T_{C}=T_{C}+C_{C}−1 (C_{c}=30, in the first embodiment) in the number-of-special-game-C storage area in the RAM 43(step S328).

After executing the processing of step S328, the main CPU 41 terminates the present subroutine.

When determining that the number of the odds-change symbol is not five in step S224, the main CPU 41 sets the remaining number T_{C} of the special game C to T_{C}=T_{C}−1 (step S329).

Next, the main CPU 41 determines whether or not the remaining number T_{B} of the special game B is T_{C}=0 (step S330). When determining that the remaining number T_{C} of the special game C is T_{C}=0 in step S330, the main CPU 41 clears the special game flag C (step S331).

When determining that the remaining number T_{C} of the special game C is not T_{C}=0, or after executing the processing of step S331, the main CPU 41 terminates the present subroutine.

There has been described the special game C execution processing (see step S500 in FIG. 6) by using FIG. 10.

As above described, the slot machine 10 according to the first embodiment is configured such that, when three odds-change symbols are rearranged in the special game C, the special game C is terminated and the special game A is executed from the next game (see step S317 to step S321). In this case, the player cannot input the disapproval order of the change.

Further, the slot machine 10 according to the first embodiment is configured such that, when four odds-change symbols are rearranged in the special game C, the special game C is terminated and the special game B is executed from the next game (see step S322 to step S326). In this case, the player cannot input the disapproval order of the change.

Furthermore, the slot machine 10 according to the first embodiment is configured such that, when five odds-change symbols are rearranged in the special game C, the remaining number of the special game C is increased (see step S327 to step S328).

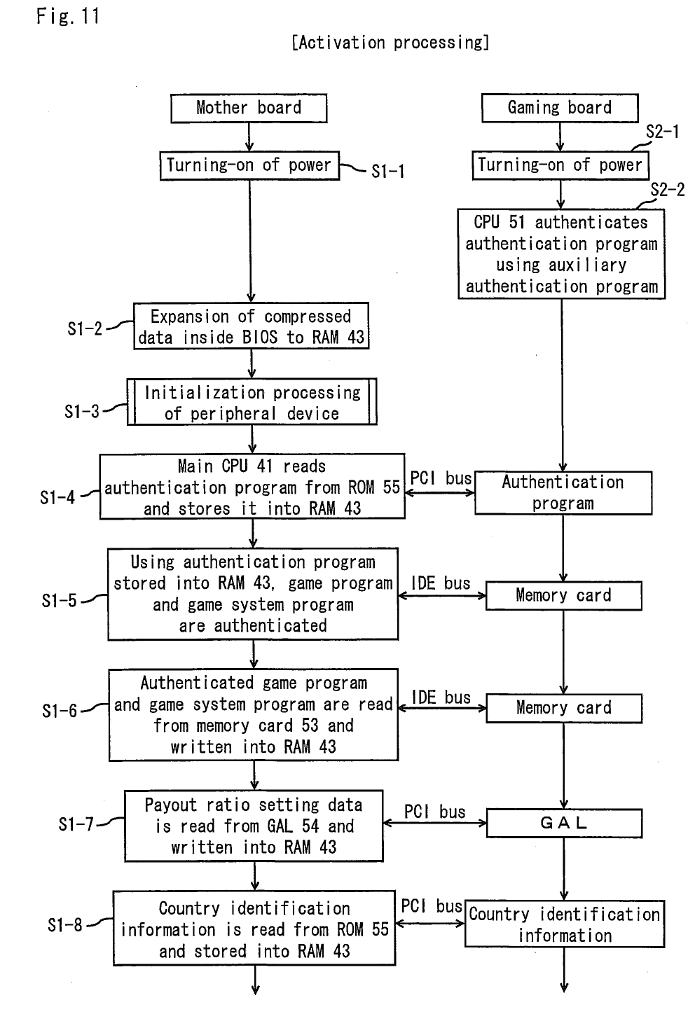

Subsequently, there will be described activation processing (see step S101 in FIG. 6) by using FIG. 11 to FIG. 13.

FIG. 11 is a flowchart illustrating a procedure of activation processing. This activation processing is the processing conducted by the mother board 40 and the gaming board 50. It should be noted that the memory card 53 is inserted into the card slot 53S in the gaming board 50, and the GAL 54 is mounted onto the IC socket 54S.

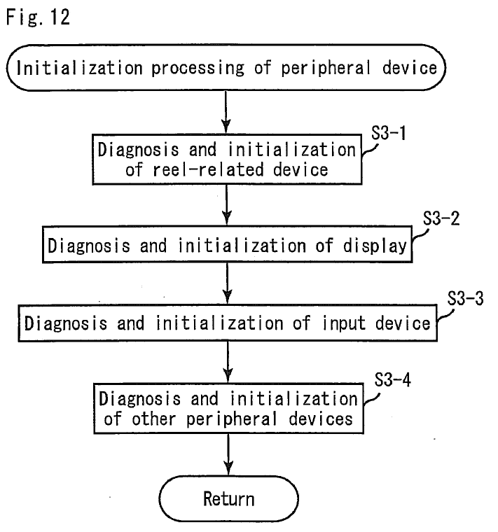

First, when a power switch is turned on (power is turned on) in the power supply unit 45, the mother board 40 and the gaming board 50 are activated (steps S1-1, S2-1). In activation of the mother board 40 and the gaming board 50, individual processing is respectively executed in parallel. Namely, in the gaming board 50, the CPU 51 reads the auxiliary authentication program stored in the boot ROM 52, and conducts auxiliary authentication according to the read auxiliary authentication program, to previously check and prove that the authentication program is not falsified before loading the program to the mother board 40 (step S2-2). Meanwhile, in the mother board 40, the main CPU 41 executes the BIOS stored in the ROM 42, and expands compressed data which is incorporated in the BIOS into the RAM 43 (step S1-2). The main CPU 41 then executes the BIOS expanded into the RAM 43 to diagnose and initialize a variety of peripheral devices (step S1-3). The processing of step S1-3 will be specifically described later with reference to FIG. 12.

Since the ROM 55 of the gaming board 50 is connected to the main CPU 41 via the PCI bus, the main CPU 41 reads the authentication program stored in the ROM 55, and stores the read authentication program into the RAM 43 (step S1-4). At this time, according to the standard BIOS function of BIOS, the main CPU 41 takes a checksum by ADDSUM system (normal checking system) and stores the authentication program into the RAM 43, while conducting processing for confirming whether or not the storage is certainly conducted.

Next, after confirming what is connected to the IDE bus, the main CPU 41 accesses, via the IDE bus, the memory card 53 inserted in the card slot 53S, to read a game program or a game system program from the memory card 53. In this case, the main CPU 41 reads data constituting the game program and the game system program by 4 bytes. Subsequently, the main CPU 41 conducts authentication to check and prove that the read game program and game system program have not been falsified, following the authentication program stored in the RAM 43 (step S1-5). When this authentication processing is normally completed, the main CPU 41 writes and stores the game program and the game system program, which have been the authentication targets (which have been authenticated), into the RAM 43 (step S1-6). Next, the main CPU 41 accesses, via the PCI bus, the GAL 54 mounted on the IC socket 54S, reads payout ratio setting data from the GAL 54, and writes and stores the data into the RAM 43 (step S1-7). Subsequently, the main CPU 41 conducts processing for reading country identification information stored in the ROM 55 of the gaming board 50 via the PCI bus, and writes and stores the read country identification information into the RAM 43 (step S1-8).

After conducting the above-mentioned processing, the main CPU 41 sequentially reads and executes the game program and the game system program, thereby execute insurance setting processing and game execution processing.

FIG. 12 is a chart illustrating a procedure of peripheral-device initialization processing.

First, the main CPU 41 diagnoses and initializes a reel-related device (step S3-1). In this processing, the main CPU 41 sequentially transmits request signals to the index detecting circuit 65, the position-change detecting circuit 71, and the motor driving circuit 62. Then, the main CPU 41 determines whether or not to have received predetermined response signals and conducts clearance of a predetermined storage area, and the like.

Next, the main CPU 41 diagnoses and initializes a display (step S3-2). In this processing, the main CPU 41 transmits the request signal to the graphic board 68. Then, the main CPU 41 determines whether or not to have received a predetermined response signal and conducts clearance of a predetermined storage area, and the like.

Next, the main CPU 41 diagnoses and initializes various types of input devices (step S3-3). In this processing, the main CPU 41 transmits request signals to the input devices such as the spin switch 23S, the change switch 24S, the CASHOUT switch 25S, the 1-BET switch 26S, the maximum BET switch 27S, and the touch panel 11, and then determines whether or not to have received predetermined response signals.

Subsequently, the main CPU 41 diagnoses and initializes other peripheral devices connected to the main CPU 41 (step S3-4). Then the present subroutine is terminated.

In the present embodiment, there has been described the case where the slot machine 10 is a stand-alone type slot machine. However, in the present invention, a plurality of slot machines may be connected to a central controller via a network and controlled by the central controller.

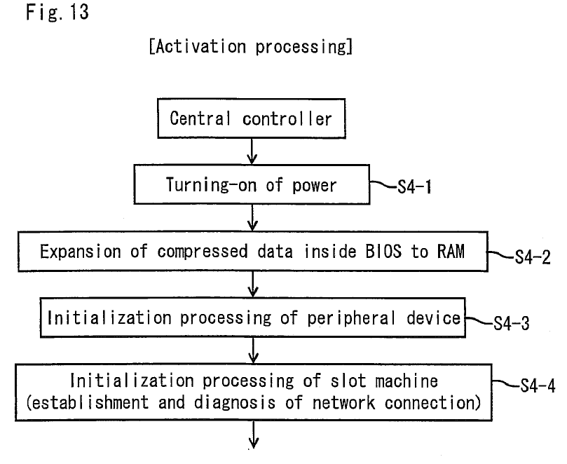

FIG. 13 is a chart illustrating a procedure of activation processing executed by the central controller shown in FIG. 13.

First, when the power switch is turned on (the power is turned on) in the power unit, a mother board is activated (step S4-1).

In the mother board, a CPU executes a BIOS stored in a ROM so as to expand compressed data incorporated in the BIOS into a RAM (step S4-2). Then, the CPU executes the BIOS expanded into the RAM, and then, diagnoses and initializes various types of peripheral devices such as a display (step S4-3).

Next, the CPU executes initialization processing of each slot machine. In this processing, the CPU establishes a network connection between the central controller and each slot machine, and diagnoses if the network functions properly.

After the above-described processing, the CPU controls proceeding of the game executed in a plurality of the slot machines by reading and executing a game control program.

There has been described the first embodiment.

When executing the following processing of (*) in cooperation, the main CPU 41 and the ROM 42 and the RAM 43 serve as the controller for executing the processing (A) in the present invention (claim 1). Further, steps of (*) correspond to the step (A) in the present invention (claim 9).

(*) Step S14 in FIG. 7, Step S114 in FIG. 8, Step S214 in FIG. 9, and Step S314 in FIG. 10

When executing the following processing of (*) in cooperation, the main CPU 41 and the ROM 42 and the RAM 43 serve as the controller for executing the processing (B) and the processing (D) in the present invention (claim 1). Further, step of (*) corresponds to the step (B) and the step (D) in the present invention (claim 9).

(*) Step S16 in FIG. 7

When executing the following processing of (*) in cooperation, the main CPU 41 and the ROM 42 and the RAM 43 serve as the controller for executing the processing (C) and the processing (D) in the present invention (claim 1). Further, step of (*) corresponds to the step (C) and the step (D) in the present invention (claim 9).

(*) Step S116 in FIG. 8, Step S216 in FIG. 9, and Step S316 in FIG. 10

When executing the following processing of (*) in cooperation, the main CPU 41 and the ROM 42 and the RAM 43 serve as the controller for executing the processing (A) in the present invention (claim 4). Further, steps of (*) correspond to the step (A) in the present invention (claim 10).

(*) Step S14 in FIG. 7

When executing the following processing of (*) in cooperation, the main CPU 41 and the ROM 42 and the RAM 43 serve as the controller for executing the processing (B) and the processing (E) in the present invention (claim 4). Further, step of (*) corresponds to the step (B) and the step (E) in the present invention (claim 10).

(*) Step S16 in FIG. 7

When executing the following processing of (*) in cooperation, the main CPU 41 and the ROM 42 and the RAM 43 serve as the controller for executing the processing (C) in the present invention (claim 4). Further, steps of (*) correspond to the step (C) in the present invention (claim 10).

(*) Step S114 in FIG. 8, Step S214 in FIG. 9, and Step S314 in FIG. 10

When executing the following processing of (*) in cooperation, the main CPU 41 and the ROM 42 and the RAM 43 serve as the controller for executing the processing (D) and the processing (E) in the present invention (claim 4). Further, step of (*) corresponds to the step (D) and the step (E) in the present invention (claim 10).

(*) Step S116 in FIG. 8, Step S216 in FIG. 9, and Step S316 in FIG. 10

Further, when executing the following processing of (I) to (III) in cooperation, the main CPU 41 and the ROM 42 and the RAM 43 serve as the controller for executing the processing (F) in the present invention (claim 5).

(I) step S19, step S24, and step S29 in FIG. 7

(II) step S121 and step S128 in FIG. 8

(III) step S226 in FIG. 9

In the first embodiment, there has been described the case where the odds are changed when the number of the rearranged odds-change symbol is three, four, or five. Here, “(The number of the rearranged odds-change symbol) being 3, 4, or 5” corresponds to the predetermined condition of the present invention. The predetermined condition of the present invention is not limited to this example, and an arbitrary number can be adopted. Further, the predetermined condition may be set to be “(The number of the odds-change symbol stop-displayed) being equal to or more than the predetermined number”. Further, the numbers according to the predetermined condition are not required to be consecutive numbers as in the first embodiment. For example, the predetermined condition may be “2, 4, or the number equal to or more than 6”.

Further, in the first embodiment, there has been described the case where the odds are changed, when the odds-change symbols in the predetermined number (3, 4, or 5) are rearranged, from the game subsequent to the game in which the odds-change symbols in the predetermined number are rearranged. However, in the present invention, a timing to change the odds is not particularly limited. The timing may be “when the games in the predetermined number are executed”. In this case, it is preferable to adopt a comparatively big number as the predetermined number of the game. This is because that adopting such a number can make the player have a motivation to continue playing the game until the odds are changed. Accordingly, it is possible that the player plays the game for a long time.

Furthermore, the slot machine may be configured such that the player can change the odds at an arbitrary timing by operating the input device.

In the first embodiment, the special odds have been described as advantageous odds for the player compared to the normal odds. However, in the present invention, the special odds may be the disadvantageous odds for the player compared to the normal odds. Further, two types of the special odds may be set, that is, the special odds advantageous for the player compared to the normal odds and the special odds disadvantageous for the player compared to the normal odds.

Further, in the first embodiment, there has been described the case where the normal symbol comprises the scatter symbol. However, in the present invention, the normal symbol is not required to comprise the scatter symbol and the slot machine may be configured such that the payout is conducted when the stop-displayed normal symbols form a predetermined winning combination (prize) on a winning line. In this case, the normal odds and the special odds may be associated only with the types of the stop-displayed normal symbols and unrelated to the number of the stop-displayed normal symbol.

Furthermore, the normal odds and the special odds of the present invention are not required to be indicative of the numbers of coin-outs in the case that a single coin is BET as in the first embodiment, and may be indicative of the constant amount of payout unrelated to the amount of the BET game media.

Further, in the first embodiment, there has been described the case that, when the number of the rearranged odds-change symbol is the predetermined number (3, 4, or 5), the odds-change text image (see FIG. 1B) is displayed and the player can input the disapproval order of the change by touching the place on the touch panel 69 corresponding to the part of “HERE” of the odds-change text image 101D. However, in the present invention, the occasion that the player can input the disapproval order of the change is not limited to this example. For example, the slot machine may be configured such that the player can input the disapproval order of change at an arbitrary timing. In this case, for example, the slot machine may be configured such that the player can input the disapproval order of change by pressing a button provided on the control panel. Further, the slot machine may be configured such that the processing according to the change in odds (for example, processing of step S17 to step S31 in FIG. 7) is not to be conducted when the odds-change symbols in the predetermined number are rearranged in the case that the disapproval order of the change has been inputted in advance.

Further, in the first embodiment, there has been described the case that the odds can be changed even during the special game period. However, in the present invention, the odds may be not changed during the special game period even when the odds-change symbols are rearranged.

According to the slot machine 10 of the first embodiment, the odds are changed as triggered by the rearrangement of the odds-change symbols in the predetermined number (3, 4, or 5). Accordingly, it becomes possible to have a player enjoy the change of the odds and thus fully enjoy the game.

Further, since the odds are changed in the case that the odds-change symbols in the predetermined number have been rearranged, it is possible to make the player have an interest and an attention on the odds-change symbol. Furthermore, it is possible to have the player play the game with a high expectation for the rearrangement of the odds-change symbols in the predetermined number, and the player can be absorbed in the game. Consequently, it is possible to provide a game that the player hardly gets tired even playing for a long time.

Further, according to the slot machine 10 of the first embodiment, the odds are changed in the case that the number of the odds-change symbol rearranged is three, four, or five. Accordingly, whether or not the number of odds-change symbol is in the range of three to five is of great concern for the player. Therefore, it is possible to have the player find great pleasure in counting the number of the odds-change symbol while playing the game. Consequently, it is possible to have the player fully enjoy the game.

According to the slot machine 10 of the first embodiment, in the case that the odds-change symbols in the predetermined number are rearranged, the odds in the game subsequent to the game in which the odds-change symbols in the predetermined number are rearranged are changed to the special odds corresponding to the number of the rearranged odds-change symbol. Namely, the changed odds can be varied according to the number of the rearranged odds-change symbol. Accordingly, it is possible to significantly increase the attention of the player on the number of the rearranged odds-change symbol.

Further, according to the slot machine 10 of the first embodiment, the BET unit (the minimum unit to BET) in the special game is bigger than the BET unit in the normal game. Accordingly, it is possible to have the player place a BET of the game medium in a big number, which leads to a profit increase of a recreation hall. Further, not only the odds, but also the BET unit is changed as triggered by the rearrangement of the odds-change symbols in the predetermined number. Accordingly, it is possible to provide an unpredictable element to the player and increase an interesting aspect of the game. Furthermore, since the player can acquire a big payout by placing a BET of the game medium in a big number under a condition of the increased BET unit, it is possible to increase the player's expectation for the payout.

Furthermore, according to the slot machine 10 of the first embodiment, the BET unit is changed to the special BET unit on condition that the disapproval order of the change has not been inputted. Namely, the player can prevent the increase in the BET unit by inputting the disapproval order of change. Accordingly, the player reluctant to BET the game media in a large number can continue the game based on the minimum BET unit. Consequently, it is possible to provide a sense of satisfaction to the player.

Moreover, according to the slot machine of the first embodiment, in the case that the disapproval order of the change is inputted, the odds are not changed. Therefore, in the case that the player wishes to change the odds while not wishing to change the BET unit, the player has choices, namely, changing the odds or not changing the BET unit. Concurrently, it is possible to have the player go through a process of trial and error in selecting either choice, and through such a process, the player can be absorbed in the game.

Further, according to the slot machine 10 of the first embodiment, the remaining number of the special game A increases when three odds-change symbols are rearranged in the special game A which is generated as triggered by the rearrangement of three odds-change symbols. The remaining number of the special game B increases when four odds-change symbols are rearranged in the special game B which is generated as triggered by the rearrangement of four odds-change symbols. The remaining number of the special game C increases when five odds-change symbols are rearranged in the special game C which is generated as triggered by the rearrangement of five odds-change symbols.

As thus described, according to the slot machine 10 of the first embodiment, when the odds-change symbols are rearranged in the same number as the number of the odds-change symbol in accordance with a generation condition of the special game, the remaining number of the special game increases. Further, the special odds are odds advantageous for the player compared to the normal odds. It is therefore possible to make the player have expectations for the rearrangement of the odds-change symbols in the same number as the number of odds-change symbols in accordance with the generation condition of the special game.

Further, according to the slot machine 10 of the first embodiment, when four odds-change symbols are rearranged in the special game A, the special game B may be executed from the next game. When five odds-change symbols are rearranged in the special game A, the special game C may be executed from the next game. When five odds-change symbols are rearranged in the special game B, the special game C may be executed from the next game.

As thus described, according to the slot machine 10 of the first embodiment, when odds-change symbols are rearranged, in a single special game, in the same number as the number of the odds-change symbol in accordance with a generation condition of another special game, another special game may be executed from the next game. In this case, another special game is a special game in which special odds are adopted which are relatively more advantageous for the player compared to the special odds in the single special game.

Hence it is possible to make the player have an expectation for a change in odds from the special odds in the single special game to the special odds in another special game (a change from the special odds A to the special odds B or to the special odds C, or a change from the special odds B to the special odds C).

Further, according to the slot machine 10 of the first embodiment, when three odds-change symbols are rearranged in the special game B, the special game B is terminated and the special game A will be executed from the next game. When three odds-change symbols are rearranged in the special game C, the special game C is terminated and the special game A will be executed from the next game. When four odds-change symbols are rearranged in the special game C, the special game C is terminated and the special game B will be played from the next game.

As thus described, according to the slot machine 10 of the first embodiment, when the odds-change symbols are rearranged, in a single special game, in the same number as the number of the odds-change symbol in accordance with a generation condition of another special game, another special game will be played from the next game. In this case, another special game is a special game in which special odds are used which are relatively more disadvantageous for the player compared to the special odds in the single special game. Furthermore, in this case, the player cannot input the disapproval order of the change.

Hence it is possible to make the player have a kind of fear in a change in odds from the special odds in the single special game to the special odds in another special game (a change from the special odds B to the special odds A, or a change from the special odds C to the special odds A or to the special odds B). It is thereby possible to provide a thrill to the player.

Further, according to the slot machine 10 of the first embodiment, with a slight difference in number of the rearranged odds-change symbols, the odds are changed to the special odds relatively advantageous for the player or to the special odds relatively disadvantageous for the player. Hence, such a slight difference in number of the rearranged odds-change symbols can greatly please or discourage the player, so as to make the player fluctuate between hopes and fears. It is thereby possible to make the player absorbed in the game.

### Second embodiment

In the first embodiment, there has been described the case that, when odds-change symbols are rearranged in the predetermined number (3, 4 or 5), odds can be changed from the game subsequent to the game in which the odds-change symbols are rearranged in the predetermined number. However, in the present invention, in the game in which the odds-change symbols are rearranged in the predetermined number, a payout based on the special odds may be conducted.

In the following, a slot machine 10 having such a configuration will be described.

It is to be noted that in the following, the same constituents as those of the slot machine 10 according to the first embodiment are described while provided with the same numerals.

Further, a description will be omitted as for a part in the second embodiment to which the description in the first embodiment is applicable.

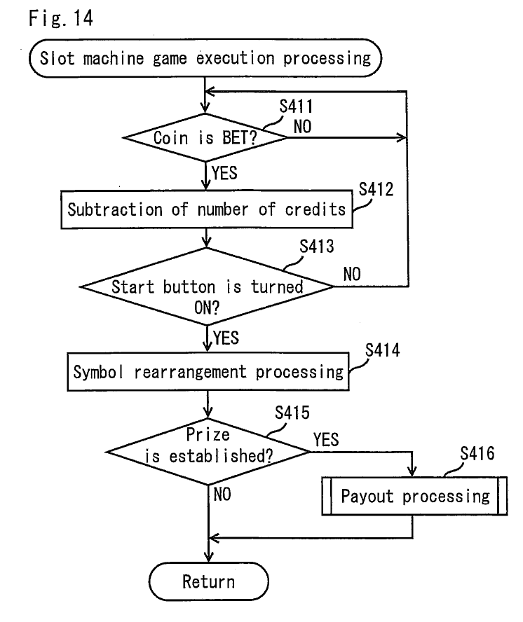

FIG. 14 is a flowchart illustrating a subroutine of slot machine game execution processing according to the second embodiment.

First, the main CPU 41 executes processing of step S411 to step S415. However, since the processing is same as the processing of step S11 to step S15 in FIG. 7, the description thereof is omitted here.

When determining in step S415 that a prize has not been established, the main CPU 41 terminates the present subroutine. On the other hand, when determining in step S415 that a prize has been established, the main CPU 41 executes payout processing (step S416), and terminates the present subroutine.

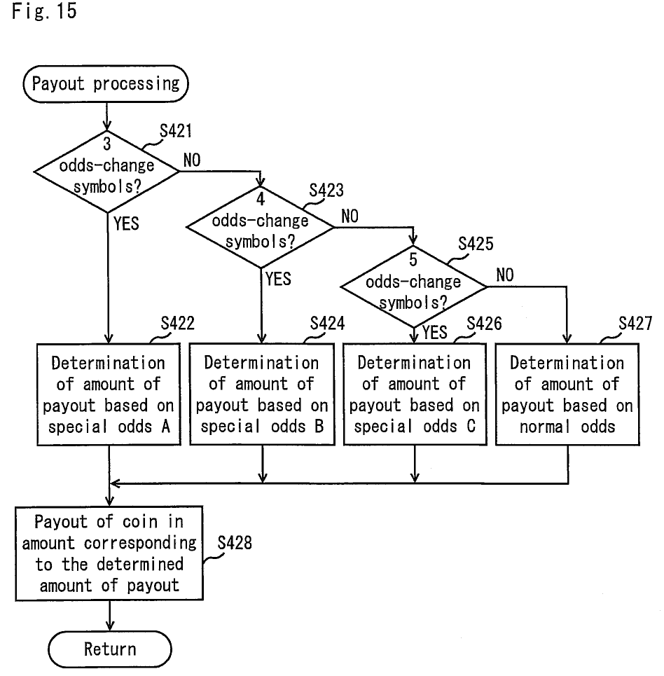

Next, the payout processing will be described by using FIG. 15.

FIG. 15 is a flowchart illustrating a subroutine of payout processing according to the second embodiment.

First, the main CPU 41 determines whether or not the number of the rearranged odds-change symbol in step S414 is three (step S421).

When determining that the number of the odds-change symbol is three, the main CPU 41 determines the amount of payout based on the type and the number of the normal symbol rearranged in step S414 with reference to the special odds A data (see FIG. 3B) stored in the RAM 43 (step S422).

The main CPU 41 then executes processing in accordance with payout of the coin in amount corresponding to the determined amount of payout (step S428) and terminates the present subroutine.

When determining that the number of the odds-change symbol is not three, the main CPU 41 determines whether or not the number of odds-change symbol is four (step S423).

When determining that the number of the odds-change symbol is four, the main CPU 41 determines the amount of payout based on the type and the number of the normal symbol rearranged in step S414 with reference to the special odds B data (see FIG. 3C) stored in the RAM 43 (step S424).

The main CPU 41 then executes processing in accordance with payout of the coin in amount corresponding to the determined amount of payout (step S428) and terminates the present subroutine.

When determining that the number of odds-change symbol is not four, the main CPU 41 determines whether or not the number of odds-change symbol is five (step S425).

When determining that the number of the odds-change symbol is five, the main CPU 41 determines the amount of payout based on the type and the number of the normal symbol rearranged in step S414 with reference to the special odds C data (see FIG. 3D) stored in the RAM 43 (step S426).

The main CPU 41 then executes processing in accordance with payout of the coin in amount corresponding to the determined amount of payout (step S428) and terminates the present subroutine.

When determining that the number of the odds-change symbol is not five, the main CPU 41 determines the amount of payout based on the type and the number of the normal symbol rearranged in step S414 with reference to the normal odds data (see FIG. 3A) stored in the RAM 43 (step S427).

The main CPU 41 then executes processing in accordance with payout of the coin in amount corresponding to the determined amount of payout (step S428) and terminates the present subroutine.

There has been described the second embodiment.

When executing the following processing of (*) in cooperation, the main CPU 41 and the ROM 42 and the RAM 43 serve as the controller for executing the processing (A) in the present invention (claim 6). Further, steps of (*) correspond to the step (A) in the present invention (claim 11).

(*) Step S414 in FIG. 14

When executing the following processing of (*) in cooperation, the main CPU 41 and the ROM 42 and the RAM 43 serve as the controller for executing the processing (B) in the present invention (claim 6). Further, step of (*) corresponds to the step (B) in the present invention (claim 11).

(*) Step S427 in FIG. 15

When executing the following processing of (*) in cooperation, the main CPU 41 and the ROM 42 and the RAM 43 serve as the controller for executing the processing (C) in the present invention (claim 6). Further, step of (*) corresponds to the step (C) in the present invention (claim 11).

(*) Step S422, Step S424, and Step S426 in FIG. 15

When executing the following processing of (*) in cooperation, the main CPU 41 and the ROM 42 and the RAM 43 serve as the controller for executing the processing (D) in the present invention (claim 6). Further, steps of (*) correspond to the step (D) in the present invention (claim 11).

(*) Step S428 in FIG. 15

According to the slot machine 10 of the second embodiment, the payout is conducted based on the special odds different from the normal odds as triggered by the rearrangement of the odds-change symbols in the predetermined number (3, 4, or 5). Accordingly, it becomes possible to have a player enjoy the variety of the odds and thus fully enjoy the game.

Further, since the payout is conducted based on the special odds in the case that the odds-change symbols in the predetermined number have been rearranged, it is possible to make the player have an interest and an attention on the odds-change symbol. Furthermore, it is possible to have the player play the game with a high expectation for the rearrangement of the odds-change symbols in the predetermined number, and the player can be absorbed in the game. Consequently, it is possible to provide a game that the player hardly gets tired even playing for a long time.

According to the slot machine 10 of the second embodiment, the payout is conducted based on the special odds in the case that the number of the rearranged odds-change symbol is three, four, or five. Accordingly, whether or not the number of the rearranged odds-change symbol is in the range of three to five is of great concern for the player. Therefore, it is possible to have the player greatly enjoy counting the number of the odds-change symbol while playing the game. Consequently, it is possible to he player fully enjoy the game.

Further, according to the slot machine 10 of the second embodiment, a payout may be conducted based on the special odds different in accordance with the number of the rearranged odds-change symbol. It is therefore possible to significantly increase the player's interest in the number of rearranged odds-change symbols.

In the first and second embodiments described above, there have been described the cases where symbols are rearranged in the symbol matrix SM of the lower image display panel 16 (the slot machine 10 is a so-called a video slot machine). However, the slot machine according to the present invention may be configured to stop-display symbols using so-called mechanical reels.

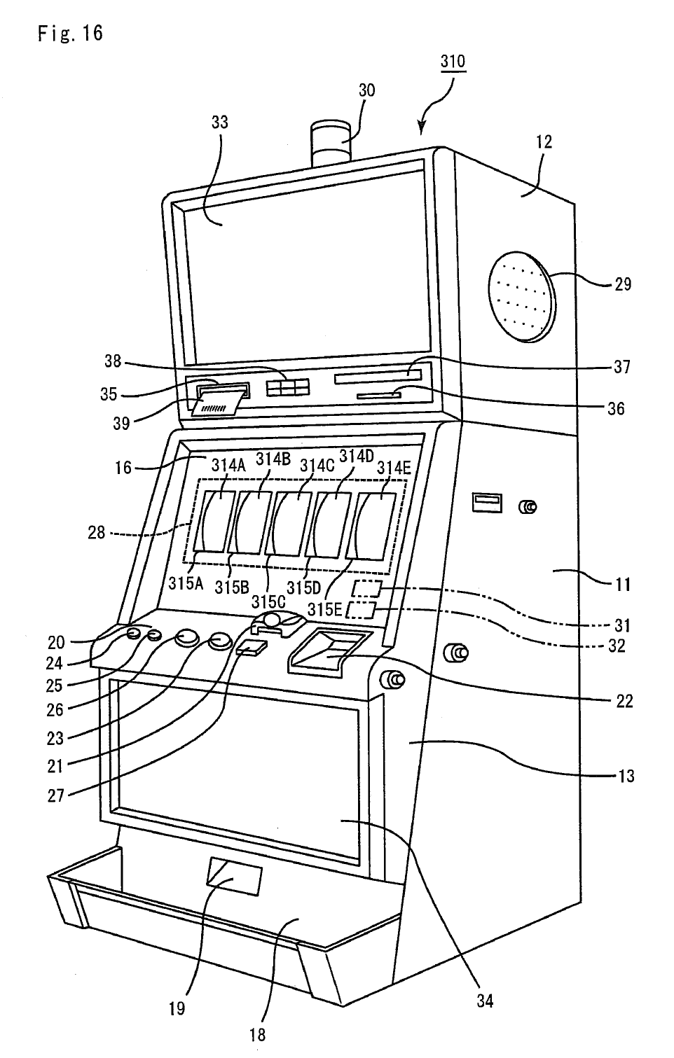

FIG. 16 is a perspective view illustrating the general appearance of a slot machine according to another embodiment.

In the following description, the components corresponding to those of the slot machine 10 will be designated by the same reference numerals.

Further, the slot machine 310 has substantially the same external appearance, the same circuit structure and the like as those of the slot machine 10 and also executes substantially the same flowcharts as those executed by the slot machine 10, except that it employs mechanical reels, and, therefore, only the mechanical reels will be described herein.

As illustrated in FIG. 16, five reels 314 (314A, 314B, 314C, 314D and 314E) are rotatably provided within a cabinet 11. On the outer peripheral surfaces of the reels 314A, 314B, 314C, 314D and 314E, there are drawn symbol sequences constituted by normal symbols such as “RIBBON”, “HEART”, “STAR”, “MOON”, “SUN”, “JEWEL”, “CROWN”, and “SMILE”, and the odds-change symbol.

At the center portion of the lower image display panel 16, there is provided a display area 328 for displaying the symbols. Within the display area 328, there are formed five display windows 315 (315A, 315B, 315C, 315D and 315E) visible through their back surfaces. Further, the symbols drawn on the outer peripheral surfaces of the reels 314A, 314B, 314C, 314D and 314E are displayed on a three-by-three basis, through the display windows 315A, 315B, 315C, 315D and 315E.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processing described in the present specification are to be executed by various types of devices, in principle. Further, other structures required for conducting each step will be apparent from the aforementioned description.

What is claimed as new and desired to be secured by Letters Patent of the United States is:

1. A slot machine comprising:
a symbol display capable of variably displaying a plurality of symbols including a normal symbol and an odds-change symbol as a trigger for changing odds; and
a controller,
said controller programmed to execute processing of
(A) stop-displaying said plurality of symbols after variably displaying said plurality of symbols, to said symbol display,
(B) determining an amount of payout based on normal odds indicating a relation between the stop-displayed normal symbol and the amount of payout and on the normal symbol stop-displayed in said processing (A),
(C) determining, when said odds-change symbol has been stop-displayed in said processing (A), the amount of payout based on special odds different from said normal odds and on the normal symbol stop-displayed in said processing (A), instead of executing said processing (B), in a game subsequent to the game in which said odds-change symbol has been stop-displayed, and
(D) paying out a game medium in the amount of payout determined in any one of said processing (B) and said processing (C).

2. The slot machine according to claim 1,
wherein
said processing (C) is processing of
determining, when a number of said odds-change symbol stop-displayed in said processing (A) satisfies a predetermined condition, the amount of payout based on said special odds and on the normal symbol stop-displayed in said processing (A), in the game subsequent to the game in which the number of the odds-change symbol stop-displayed has satisfied the predetermined condition.

3. The slot machine according to claim 2,
wherein
said processing (C) is processing of
determining the amount of payout based on the special odds corresponding to the number of the odds-change symbol stop-displayed in said processing (A) and on the normal symbol stop-displayed in said processing (A).

4. A slot machine comprising:
a symbol display capable of variably displaying a plurality of symbols including a normal symbol and an odds-change symbol as a trigger for changing odds; and
a controller,
said controller programmed to execute processing of
(A) stop-displaying said plurality of symbols after variably displaying said plurality of symbols, to said symbol display, following a BET of a game medium in amount corresponding to natural number multiple of a predetermined minimum BET unit;
(B) determining an amount of payout based on normal odds indicating a relation between the stop-displayed normal symbol and the amount of payout and on the normal symbol stop-displayed in said processing (A),
(C) stop-displaying, when said odds-change symbol is stop-displayed in said processing (A), said plurality of symbols after variably displaying said plurality of symbols, to said symbol display, following the BET of the game medium in amount corresponding to the natural number multiple of a special BET unit bigger than said minimum BET unit, in a game subsequent to the game in which the odds-change symbol has been stop-displayed,
(D) determining the amount of payout based on special odds different from said normal odds and on the normal symbol stop-displayed in said processing (C), and
(E) paying out the game medium in the amount of payout determined in any one of said processing (B) and said processing (D).

5. The slot machine according to claim 4 further comprising
an input device with which a player can input an order relating to the game,
wherein
said controller is further programmed to execute processing of:
(F) accepting from said input device an input of an disapproval order of a change indicating disapproval for the change in odds, and
said processing (C) is processing of
stop-displaying said plurality of symbols after variably displaying said plurality of symbols, to said symbol display, following the BET of the game medium in amount corresponding to the natural number multiple of said special BET unit, on condition that the input of said disapproval order of the change has not been made in said processing (F).

6. A slot machine comprising:
a symbol display capable of stop-displaying a plurality of symbols including a normal symbol and an odds-change symbol as a trigger for changing odds after variably displaying said plurality of symbols;
a memory capable of storing normal odds data indicating a relation between the normal symbol stop-displayed to said symbol display and an amount of payout and being to be referred to when said odds-change symbol has not been stop-displayed, and special odds data to be referred to when said odds-change symbol has been stop-displayed; and
a controller,
said controller programmed to execute processing of
(A) stop-displaying said plurality of symbols after variably displaying said plurality of symbols, to said symbol display,
(B) determining the amount of payout based on the normal symbol stop-displayed in said processing (A) and on said normal odds data stored in said memory when said odds-change symbol has not been stop-displayed in said processing (A),
(C) determining the amount of payout based on the normal symbol stop-displayed in said processing (A) and on said special odds data stored in said memory, when said odds-change symbol has been stop-displayed in said processing (A),
(D) paying out a game medium in the amount of payout determined in any one of said processing (B) and said processing (C).

7. The slot machine according to claim 6,
wherein
said processing (C) is processing of
determining the amount of payout based on the normal symbol stop-displayed in said processing (A) and on said special odds data stored in said memory, when a number of the odds-change symbol stop-displayed in said processing (A) satisfies a predetermined condition.

8. The slot machine according to claim 7,
wherein
a plurality of said special odds data are stored in said memory, and
each special odds data is associated with the number of the odds-change symbol stop-displayed to said symbol display, and
said processing (C) is processing of
determining the amount of payout based on the normal symbol stop-displayed in said processing (A) and on the special odds data associated with the number of the odds-change symbol stop-displayed in said processing (A).

9. A control method of a slot machine, said control method comprising steps of:
(A) stop-displaying a plurality of symbols including a normal symbol and an odds-change symbol as a trigger for changing odds, after variably displaying said plurality of symbols to said symbol display;
(B) determining an amount of payout based on normal odds indicating a relation between the stop-displayed normal symbol and the amount of payout and on the normal symbol stop-displayed in said step (A);
(C) determining, when said odds-change symbol has been stop-displayed in said step (A), the amount of payout based on special odds different from said normal odds and on the normal symbol stop-displayed in said step (A), instead of executing said step (B), in a game subsequent to the game in which said odds-change symbol has been stop-displayed, and
(D) paying out a game medium in the amount of payout determined in any one of said step (B) and said step (C).

10. A control method of a slot machine, said control method comprising steps of:
(A) stop-displaying a plurality of symbols including a normal symbol and an odds-change symbol as a trigger for changing odds, after variably displaying said plurality of symbols to said symbol display, following a BET of a game medium in amount corresponding to natural number multiple of a predetermined minimum BET unit;
(B) determining an amount of payout based on normal odds indicating a relation between the stop-displayed normal symbol and the amount of payout and on the normal symbol stop-displayed in said step (A),
(C) stop-displaying, when said odds-change symbol is stop-displayed in said step (A), said plurality of symbols after variably displaying said plurality of symbols, to said symbol display, following the BET of the game medium in amount corresponding to the natural number multiple of a special BET unit bigger than said minimum BET unit, in a game subsequent to the game in which the odds-change symbol has been stop-displayed,
(D) determining the amount of payout based on special odds different from said normal odds and on the normal symbol stop-displayed in said step (C), and
(E) paying out the game medium in the amount of payout determined in any one of said step (B) and said step (D).

11. A control method of a slot machine, said control method comprising steps of:
(A) stop-displaying a plurality of symbols including a normal symbol and an odds-change symbol as a trigger for changing odds after variably displaying said plurality of symbols, to said symbol display,
(B) determining an amount of payout based on the normal symbol stop-displayed in said step (A) and on normal odds data indicating a relation between the stop-displayed normal symbol and the amount of payout, when said odds-change symbol has not been stop-displayed in said step (A),
(C) determining the amount of payout based on the normal symbol stop-displayed in said step (A) and on said special odds data different from said normal odds data, when said odds-change symbol has been stop-displayed in said step (A), and
(D) paying out a game medium in the amount of payout determined in any one of said step (B) and said step (C).
